(19) United States
(12) Patent Application Publication
(10) Pub. No.: US 2025/0300782 A1
(43) Pub. Date: Sep. 25, 2025

(54) DEMODULATION REFERENCE SIGNAL (DMRS) TRANSMISSION METHOD, AND APPARATUS

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/862,804

(22) PCT Filed: May 5, 2022
(86) PCT No.: PCT/CN2022/091053

§ 371 Date: Nov. 4, 2024

(51) Int. Cl. H04L 5/00

(52) U.S. Cl. CPC H04L 5/0051; H04L 5/0007

(57) ABSTRACT

A demodulation reference signal (DMRS) transmission method, including: determining, by a network device, that a conflict condition is satisfied; generating an additional DMRS; and transmitting a cell-specific reference signal (CRS) and the additional DMRS by means of an orthogonal cover code (OCC).

### CROSS-REFERENCE TO RELATED APPLICATION

The present application is a U.S. National Stage of International Application No. PCT/CN2022/091053, filed on May 5, 2022, the contents of all of which are incorporated herein by reference in their entireties for all purposes.

### BACKGROUND OF THE INVENTION

New Radio (NR) is a proposed fifth generation (5G) wireless communication protocol that will provide unified connectivity for smartphones, vehicles, utility meters, wearable devices, and other wireless-enabled devices. A 5G NR wireless network has the capacity to dynamically re-utilize unused bandwidth of a fourth generation (4G) long term evolution (LTE) wireless network.

### SUMMARY OF THE INVENTION

The disclosure relates to the field of communication technology, and in particular to a demodulation reference signal (DMRS) transmission method and apparatus.

In a first aspect, a demodulation reference signal (DMRS) transmission method is provided. The DMRS transmission method is performed by a network device, and includes: determining that a collision condition is satisfied; generating an additional demodulation reference signal (DMRS); and transmitting a cell-specific reference signal (CRS) and the additional DMRS by means of orthogonal cover code (OCC).

In a second aspect, another demodulation reference signal (DMRS) transmission method is provided. The DMRS transmission method is performed by a network device, and includes: determining that a collision condition is satisfied; determining a position of a shifted resource element (RE) by means of shifting in frequency domain; and transmitting a first DMRS at the position of the shifted RE.

In a third aspect, yet another demodulation reference signal (DMRS) transmission method is provided. The DMRS transmission method is performed by a terminal, and includes: determining that a collision condition is satisfied; and receiving an additional DMRS transmitted by a network device; where the additional DMRS is generated by the network device, and a cell-specific reference signal (CRS) and the additional DMRS are transmitted by the network device by means of an orthogonal cover code (OCC).

In a fourth aspect, still another demodulation reference signal (DMRS) transmission method is provided. The DMRS transmission method is performed by a terminal, and includes: determining that a collision condition is satisfied; and receiving a first DMRS at a position of a shifted resource element (RE); where the position of the shifted RE is determined by means of shifting in frequency domain.

In a fifth aspect, a communication apparatus is provided. The communication apparatus has some or all functions of the network device in the method in the first aspect. For example, the communication apparatus may have functions in some or all the examples of the disclosure, or may have functions independently implementing any example of the disclosure. The functions may be implemented through hardware, or may be implemented by executing corresponding software by hardware. The hardware or software includes one or more units or modules corresponding to the functions. The communication apparatus includes: a processing module configured to determine that a collision condition is satisfied, where the processing module is further configured to generate an additional demodulation reference signal (DMRS); and a transceiving module configured to transmit a cell-specific reference signal (CRS) and the additional DMRS by means of an orthogonal cover code (OCC).

In a sixth aspect, a communication apparatus is provided. The communication apparatus has some or all functions of the network device in the method in the second aspect. For example, the communication apparatus may have functions in some or all the examples of the disclosure, or may have functions independently implementing any example of the disclosure. The functions may be implemented through hardware, or may be implemented by executing corresponding software by hardware. The hardware or software includes one or more units or modules corresponding to the functions. The communication apparatus includes: a processing module configured to determine that a collision condition is satisfied, where the processing module is further configured to determine a position of a shifted resource element (RE) by means of shifting in frequency domain; and a transceiving module configured to transmit a first demodulation reference signal (DMRS) at the position of the shifted RE.

In a seventh aspect, another communication apparatus is provided. The communication apparatus has some or all functions of the terminal in the method in the third aspect. For example, the communication apparatus may have functions in some or all the examples of the disclosure, or may have functions independently implementing any example of the disclosure. The functions may be implemented through hardware, or may be implemented by executing corresponding software by hardware. The hardware or software includes one or more units or modules corresponding to the functions. The communication apparatus includes: a processing module configured to determine that a collision condition is satisfied; and a transceiving module configured to receive an additional demodulation reference signal (DMRS) transmitted by a network device, where the additional DMRS is generated by the network device, and a cell-specific reference signal (CRS) and the additional DMRS are transmitted by the network device by means of an orthogonal cover code (OCC).

In an eighth aspect, yet another communication apparatus is provided. The communication apparatus has some or all functions of the terminal in the method in the fourth aspect. For example, the communication apparatus may have functions in some or all the examples of the disclosure, or may have functions independently implementing any example of the disclosure. The functions may be implemented through hardware, or may be implemented by executing corresponding software by hardware. The hardware or software includes one or more units or modules corresponding to the functions. The communication apparatus includes: a processing module configured to determine that a collision condition is satisfied; and a transceiving module configured to receive a first demodulation reference signal (DMRS) at a position of a shifted resource element (RE), where the position of the shifted RE is determined by means of shifting in frequency domain.

In a ninth aspect, a communication apparatus is provided. The communication apparatus includes a processor, where when invoking a computer program in a memory, the processor executes the method in the first aspect or the second aspect.

In a tenth aspect, a communication apparatus is provided. The communication apparatus includes a processor, where when invoking a computer program in a memory, the processor executes the method in the third aspect or the fourth aspect.

In an eleventh aspect, a communication apparatus is provided. The communication apparatus includes a processor and a memory, where the memory stores a computer program, and the processor causes the communication apparatus to execute the method in the first aspect or the second aspect by executing the computer program stored in the memory.

In a twelfth aspect, a communication apparatus is provided. The communication apparatus includes a processor and a memory, where the memory stores a computer program, and the processor causes the communication apparatus to execute the method in the third aspect or the fourth aspect by executing the computer program stored in the memory.

In a thirteenth aspect, a communication apparatus is provided. The communication apparatus includes a processor and an interface circuit, where the interface circuit is configured to receive a code instruction and transmit the code instruction to the processor, and the processor is configured to cause the communication apparatus to execute the method in the first aspect or the second aspect by running the code instruction.

In a fourteenth aspect, a communication apparatus is provided. The communication apparatus includes a processor and an interface circuit, where the interface circuit is configured to receive a code instruction and transmit the code instruction to the processor, and the processor is configured to cause the communication apparatus to execute the method in the third aspect or the fourth aspect by running the code instruction.

In a fifteenth aspect, a communication system is provided. The communication system includes the communication apparatus in the fifth aspect and the communication apparatus in the seventh aspect. Alternatively, the communication system includes the communication apparatus in the sixth aspect and the communication apparatus in the eighth aspect. Alternatively, the communication system includes the communication apparatus in the ninth aspect and the communication apparatus in the tenth aspect. Alternatively, the communication system includes the communication apparatus in the eleventh aspect and the communication apparatus in the twelfth aspect. Alternatively, the communication system includes the communication apparatus in the thirteenth aspect and the communication apparatus in the fourteenth aspect.

In a sixteenth aspect, a non-transitory computer-readable storage medium is provided. The non-transitory computer-readable storage medium is configured to store an instruction used by a network device, where the instruction, when being executed, causes the network device to execute the method in the first aspect or the second aspect.

In a seventeenth aspect, a non-transitory computer-readable storage medium is provided. The non-transitory computer-readable storage medium is configured to store an instruction used by a terminal, where the instruction, when being executed, causes the terminal to execute method in the third aspect or the fourth aspect.

In an eighteenth aspect, the disclosure further provides a computer program product including a computer program. When running on a computer, the computer program product causes the computer to execute the method in the first aspect or the second aspect.

In a nineteenth aspect, the disclosure further provides a computer program product including a computer program. When running on a computer, the computer program product causes the computer to execute the method in the third aspect or the fourth aspect.

In a twentieth aspect, the disclosure provides a chip system. The chip system includes at least one processor and an interface, and is configured to support a network device in implementing functions involved in the first aspect or the second aspect, such as determination or processing of at least one of data or information involved in the mentioned methods. In an example, the chip system further includes a memory, where the memory is configured to save a computer program and data necessary for the mentioned terminal. The chip system may be composed of a chip, and may also include a chip and other discrete devices.

In a twenty-first aspect, the disclosure provides a chip system. The chip system includes at least one processor and an interface, and is configured to support a terminal in implementing functions involved in the third aspect or the fourth aspect, such as determination or processing of at least one of data or information involved in the mentioned methods. In an example, the chip system further includes a memory, where the memory is configured to save a computer program and data necessary for the mentioned network device. The chip system may be composed of a chip, and may also include a chip and other discrete devices.

In a twenty-second aspect, the disclosure provides a computer program. When running on a computer, the computer program causes the computer to execute the method in the first aspect or the second aspect.

In a twenty-third aspect, the disclosure provides a computer program. When running on a computer, the computer program causes the computer to execute the method in the third aspect or the fourth aspect.

### BRIEF DESCRIPTION OF DRAWINGS

In order to describe the technical solutions in examples of the disclosure or the background art more clearly, the accompanying drawings required to be used in the examples of the disclosure or the background art will be described below.

FIG. 1 is a schematic diagram of a resource block (RB) under a new radio (NR) system according to an example of the disclosure.

FIG. 2 is a schematic diagram of a sub frame in long term evolution (LTE).

FIG. 3 is another schematic diagram of a sub frame in LTE.

FIG. 4 is a schematic diagram of a slot in NR.

FIG. 5 is a diagram of an architecture of a communication system according to an example of the disclosure.

FIG. 6 is a flowchart of a demodulation reference signal (DMRS) transmission method according to an example of the disclosure.

FIG. 7 is a schematic diagram of an orthogonal cover code of time domain (TD-OCC) condition according to an example of the disclosure.

FIG. 8 is a schematic diagram of multiplexing by means of TD-OCC according to an example of the disclosure.

FIG. 9 is a schematic diagram of another multiplexing by means of TD-OCC according to an example of the disclosure.

FIG. 10 is a schematic diagram of another TD-OCC condition according to an example of the disclosure.

FIG. 11 is a schematic diagram of yet another multiplexing by means of TD-OCC according to an example of the disclosure.

FIG. 12 is a schematic diagram of still another multiplexing by means of TD-OCC according to an example of the disclosure.

FIG. 13 is a flowchart of another demodulation reference signal (DMRS) transmission method according to an example of the disclosure.

FIG. 14 is a flowchart of yet another DMRS transmission method according to an example of the disclosure.

FIG. 15 is a flowchart of yet another DMRS transmission method according to an example of the disclosure.

FIG. 16 is a flowchart of yet another DMRS transmission method according to an example of the disclosure.

FIG. 17 is a flowchart of yet another DMRS transmission method according to an example of the disclosure.

FIG. 18 is a flowchart of yet another DMRS transmission method according to an example of the disclosure.

FIG. 19 is a flowchart of still another DMRS transmission method according to an example of the disclosure.

FIG. 20 is a structural diagram of a communication apparatus according to an example of the disclosure.

FIG. 21 is a structural diagram of a communication apparatus according to an example of the disclosure.

FIG. 22 is a schematic structural diagram of a chip according to an example of the disclosure.

### DETAILED DESCRIPTION OF THE INVENTION

In order to facilitate understanding of the technical solutions of the disclosure, some terms involved in examples of the disclosure are briefly described.

1. Frame structure parameter. The frame structure parameter can also be referred to as a system parameter, or numerology, etc. For example, the frame structure parameter can include at least one of sub-carrier spacing (SCS) or a type of a cyclic prefix (CP), etc. In an example, different kinds of sub-carrier spacing are supported in NR, such as 15 kHz sub-carrier spacing, 30 kHz sub-carrier spacing, 60 kHz sub-carrier spacing, 120 kHz sub-carrier spacing, and 240 kHz sub-carrier spacing. In an example, 15 kHz sub-carrier spacing is generally supported in LTE.

2. Symbol. The symbol involved in the examples of the disclosure refers to an orthogonal frequency division multiplexing (OFDM) symbol, and data is generally transmitted in time domain with the symbol as granularity. The 15 kHz sub-carrier spacing is supported in the LTE. Different kinds of sub-carrier spacing are supported in the NR, and duration of symbols corresponding to different kinds of sub-carrier spacing are also different.

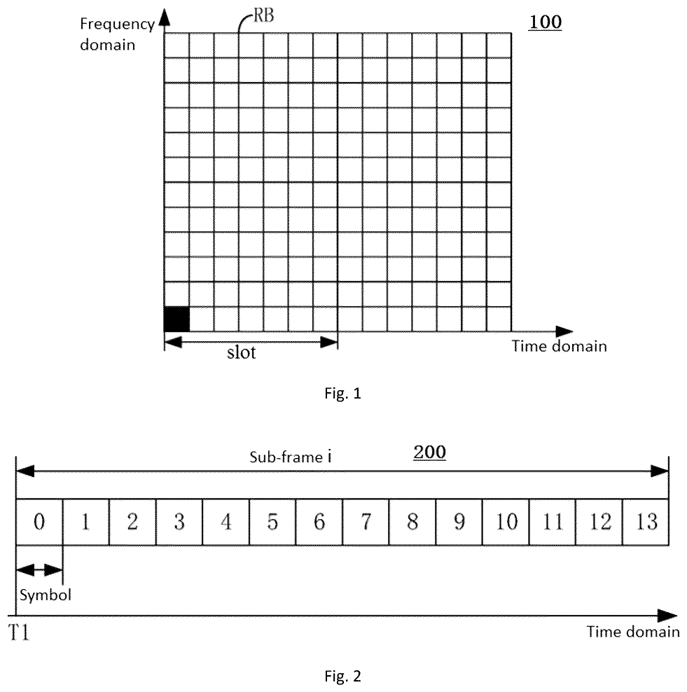

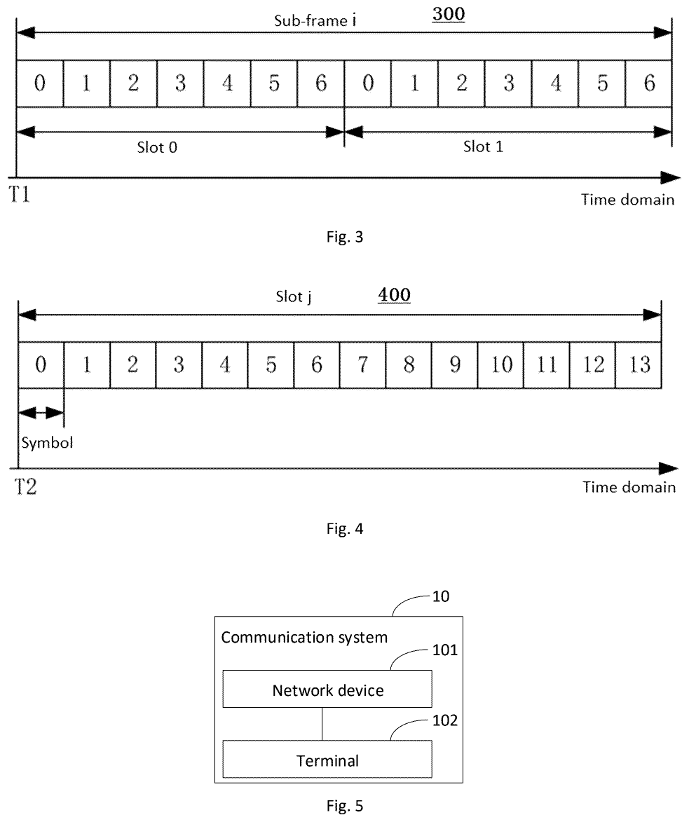

3. Resource block (RB). In the LTE, resources are scheduled at a granularity of 2 RBs. In an example, as shown in FIG. 1, one RB 100 includes 7 symbols in time domain and 12 sub-carriers in frequency domain, where the sub-carrier spacing is 15 kHz. In an example, in the LTE, 7 symbols can constitute one slot, and 14 symbols can constitute one sub-frame. A minimum resource granularity for data transmission is a resource element (RE), which includes one sub-carrier in the frequency domain and one symbol in the time domain, as shown by a black shaded part in FIG. 1. In addition, in the LTE, resource scheduling is performed in the time domain with the sub-frame as granularity, and a minimum time granularity for data transmission in the time domain is the symbol. Thus, different symbols on one sub-frame can be sequentially identified in a time sequence for distinguishment. For example, different symbols are identified in sub-frame. As shown in FIG. 2, in the LTE, a sub-frame i 200 includes 14 symbols, i.e. a symbol 0, a symbol 1, a symbol 2, a symbol 3, a symbol 4, a symbol 5, a symbol 6, a symbol 7, a symbol 8, a symbol 9, a symbol 10, a symbol 11, a symbol 12, and a symbol 13. For another example, different symbols are identified in slot. As shown in FIG. 3, in the LTE, a sub-frame i 300 includes a slot 0 and a slot 1, where the slot 0 includes 7 symbols, i.e. a symbol 0, a symbol 1, a symbol 2, a symbol 3, a symbol 4, a symbol 5, and a symbol 6; and the slot 1 includes 7 symbols, i.e. a symbol 0, a symbol 1, a symbol 2, a symbol 3, a symbol 4, a symbol 5, and a symbol 6. i denotes a sub-frame number, which can be a positive integer such as 0, 1, and 2.

4. Slot. In the LTE, one slot includes 7 symbols. In the NR, a number of symbols included in one slot is related to a type of the CP. For a normal CP, one slot includes 14 symbols. For an extended CP, one slot includes 12 symbols. In addition, it is to be noted that in the NR, resource scheduling is performed in the time domain with the slot as granularity, and the minimum time granularity for data transmission in the time domain is the symbol. Thus, different symbols in one slot can be sequentially identified in a time sequence for distinguishment. For example, as shown in FIG. 4, in the NR, a slot j 400 includes 14 symbols, i.e. a symbol 0, a symbol 1, a symbol 2, a symbol 3, a symbol 4, a symbol 5, a symbol 6, a symbol 7, a symbol 8, a symbol 9, a symbol 10, a symbol 11, a symbol 12, and a symbol 13, where j denotes a slot number, which can be a positive integer such as 0, 1, and 2.

5. Demodulation reference signal (DMRS). In the NR, the DMRS can be used by a terminal to perform channel estimation. Sub-carriers occupied by the DMRS on one symbol are related to a type of the DMRS, a code division multiplexing (CDM) group number indicated by downlink control information (DCI), etc. In addition, a length of one DMRS in the time domain can be one symbol or K consecutive symbols, where K can be 2 or a positive integer greater than 2. It is to be noted that in a case that the length of the DMRS in the time domain is one symbol, the DMRS can also be referred to as a single-symbol DMRS or a 1-symbol DMRS, etc. In a case that the length of the DMRS in the time domain is two consecutive symbols, the DMRS can also be referred to as a double-symbol DMRS or a 2-symbol DMRS, etc. A DMRS corresponding to a physical downlink control channel (PDCCH) will be described in detail below.

6. Cell-specific reference signal (CRS). In the LTE, the CRS may be used by the terminal to perform channel estimation, and may also be used by the terminal to perform downlink channel quality measurement, such as reference signal receiving power (RSRP) measurement. After receiving the CRS, the terminal can perform channel estimation according to the CRS, and demodulate a control channel or a data channel according to a channel estimation result. Thus, the terminal may acquire control information transmitted in the physical downlink control channel (PDCCH) or data transmitted in a physical downlink shared channel (PDSCH). For example, the network device may transmit the CRS to the terminal through one or more antenna ports, so as to improve accuracy of channel estimation.

In addition, REs actually occupied by the CRS are also related to a shift value of the CRS. The shift value equals a result of physical cell identity (ID) modulus 6 of a carrier. The shift value of the CRS indicates a cyclic shift of a resource for the CRS in the frequency domain. However, since patterns of the DMRS and the CRS are generally fixed, in a case that the NR shares a spectrum resource with the LTE, if a time domain resource occupied by the DMRS conflicts with a time domain resource occupied by the CRS, mutual interference between the DMRS and the CRS is likely to be caused. In other words, both reception of the CRS by the terminal in the LTE for channel estimation or channel quality measurement such as RSRP, and reception of the DMRS by the terminal in the NR for channel estimation are affected. It is to be noted that in a case that the NR shares the spectrum resource with the LTE, the NR and the LTE are time-aligned in the time domain. For example, a start time of the slot j in the NR is identical to a start time of the sub-frame i in the LTE, where i and j can be the same or not. For example, as shown in FIG. 2 or FIG. 3, T1 denotes the start time of the sub-frame i, and as shown in FIG. 4, T2 denotes the start time of the slot j, where T1 is identical to T2. Thus, the NR and the LTE are time-aligned in the time domain.

The CRS is configured for the downlink channel quality measurement such as the RSRP, etc., and for the downlink channel estimation, so that the terminal may perform coherent demodulation. Antenna ports for the CRS are configurable, and 4 antenna ports can be configured at most. The CRS can be transmitted on sub-frames of Δf=15 KHz only.

1. Sequence generation: a CRS sequence symbol r_{l,n,}(m) corresponding to a CRS pattern may be generated as follows:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , m = 0 , 1 , … , 2 {N}_{RB}^{max , DL} - 1$$

where N_{RB}^{max,DL}=110, and denotes a number of RBs occupied by a downlink maximum bandwidth, nₛ denotes a number of slots in one wireless frame, c denotes a pseudorandom sequence, j denotes a imaginary part, and l denotes an intra-slot OFDM index. An initial value cᵢₙᵢₜ of the pseudorandom sequence is defined based on a formula as follows:

$$\begin{matrix}{c}_{init} = {2}^{10} \cdot ( 7 \cdot ( {n}_{s}^{′} + 1 ) + l + 1 ) \cdot ( 2 \cdot {N}_{ID}^{cell} + 1 ) + 2 \cdot {N}_{ID}^{cell} + {N}_{CP} \\ {n}_{s}^{′} = \{ \begin{matrix}10 ⌊ {n}_{s} / 10 ⌋ + {n}_{s} mod 2 & for frame structure type 3 when the CRS is part of a DRS \\ {n}_{s} & otherwise\end{matrix} where \\ {N}_{C P} = \{ \begin{matrix}1 & for normal CP \\ 0 & for extended CP\end{matrix}\end{matrix}$$

where N_{ID}^{cell} denotes a physical cell identity.

A mapping relation between a CRS sequence symbol r_{l,n,}(m) transmitted on a slot nₛ and an antenna port p, and an OFDM resource (k, l) satisfies a condition as follows:

$$\begin{matrix}k = 6 m + ( v + {v}_{s {h}_{1} 1 𝔦} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL}\end{matrix}$$

where N_{RB}^{DL} denotes a number of RBs occupied by a downlink (DL) configured bandwidth, N_{symb}^{DL} denotes a number of OFDM symbols occupied in one slot, cell-level symbol shift ν_{shift}=N_{ID}^{cell}mod6, a physical cell identity (PCI) N_{ID}^{cell} is configured by high-layer signaling, and a variable ν equals:

$$v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3\end{matrix}$$

It is to be noted that, in a case that the resource element (k, l) is configured to transmit a CRS of a specific antenna port, the resource element (k, l) cannot be configured to transmit CRSs of other antenna ports.

### 2. PDCCH DMRS:

### 1) Sequence Generation:

For the OFDM symbol l in one slot, a corresponding sequence rₗ(m) satisfies a condition as follows:

$${r}_{l} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where c(i) denotes a pseudorandom sequence, of which an initial value satisfies a condition as follows:

$${c}_{init} = ( {2}^{17} ( {N}_{symb}^{slot} {n}_{s , f}^{μ} + l + 1 ) ( 2 {N}_{ID} + 1 ) + 2 {N}_{ID} ) mod {2}^{31}$$

where N_{symb}^{slot} denotes a number of symbols in one slot, s denotes a slot, f denotes a frame, μ denote sub-carrier spacing (SCS), n_{s,f}^{μ} denotes an intra-frame slot index, and is N_{ID}∈{0, 1 . . . , 65535} configured by a high-layer parameter pdcch-DMRS-Scrambling ID, otherwise N_{ID}=N_{ID}^{cell}.

### 2) Resource Mapping

$${a}_{k , l}^{( p ,} = {β}_{DMRS}^{PDCCH} \cdot {r}_{k , l}^{( dmrs )}$$

The sequence rₗ(m) is mapped to the resource element (k, l)_{p,μ}, and a condition as follows is satisfied:

$$\begin{matrix}{a}_{k ,}^{( p , μ )} = {β}_{DMRS}^{PDCCH} \cdot {r}_{l} ( 3 n + {k}^{′} ) \\ k = n {N}_{sc}^{RB} + 4 {k}^{′} + 1 \\ {k}^{′} = 0 , 1 , 2 \\ n = 0 , 1 , …\end{matrix}$$

where a_{k,l}^{(p,μ)} denotes mapping the sequence rₗ(m) to resource element (k, l)_{p,μ}; r_{k,l}^{(dmrs)} denotes a DMRS sequence transmitted on the resource element (k, l); N_{sc}^{RB} denotes a number of sub-carriers occupied by one RB; β_{DMRS}^{PDCCH} denotes a transmission power parameter, k denotes a sub-carrier index in the OFDM symbol, I denotes an intra-slot symbol index, and an antenna port p=2000.

In an RB where a PDCCH DMRS exists, the DMRS is transmitted on the first, fifth, and ninth sub-carriers in one RB.

New Radio (NR) is a proposed fifth generation (5G) wireless communication protocol that will provide unified connectivity for smartphones, vehicles, utility meters, wearable devices, and other wireless-enabled devices. A 5G NR wireless network has the capacity to dynamically re-utilize unused bandwidth of a fourth generation (4G) long term evolution (LTE) wireless network.

On a frequency band where LTE and NR coexist, LTE cell-specific reference signal (CRS) needs to be continuously transmitted, which will interfere with an NR physical downlink control channel (PDCCH).

In order to better understand a demodulation reference signal (DMRS) transmission method and apparatus disclosed in the examples of the disclosure, a communication system applicable to the examples of the disclosure is first described below.

With reference to FIG. 5, FIG. 5 is a schematic diagram of an architecture of a communication system according to an example of the disclosure. The communication system 10 may include, but is not limited to, one network device 101 and one terminal 102. Numbers and forms of the devices shown in FIG. 5 are illustrative, and do not limit the example of the disclosure. In practical application, two or more network devices and two or more terminals may be included. The communication system 10 shown in FIG. 5 includes one network device 101 and one terminal 102 as an example.

It is to be noted that the technical solution in the example of the disclosure may be applied to various communication systems, for example, a long term evolution (LTE) system, a 5th generation (5G) mobile communication system, a 5G new radio (NR) system, or other future novel mobile communication systems, etc.

The network device 101 is an entity located at a network side and configured to transmit or receive signals. For example, the network device 101 may be an evolved Node B (eNB), a transmission reception point (TRP), a next generation Node B (gNB) in an NR system, a network device in other future mobile communication systems, or an access node in a wireless fidelity (WiFi) system, etc. The specific technology and the specific device form employed by the network device 101 are not limited in the example of the disclosure. The network device 101 according to the example of the disclosure may be composed of a central unit (CU) and a distributed unit (DU), where the CU may also be referred to as a control unit. With the CU-DU structure, the network device 101, such as protocol layers of the network device 101, may be split, functions of some protocol layers may be placed in the CU for central control, and functions of part or all of remaining protocol layers may be distributed in the DU, and the DU is centrally controlled by the CU.

The terminal 102 is an entity located at a user side and configured to receive or transmit signals, such as a mobile phone. The terminal 102 may also be referred to as a terminal, user equipment (UE), a mobile station (MS), a mobile terminal (MT), etc. The terminal 102 may be a vehicle, smart vehicle, mobile phone, wearable device, and pad having a function of communication; and a computer, virtual reality (VR) terminal, augmented reality (AR) terminal, wireless terminal in industrial control, wireless terminal in self-driving, wireless terminal in remote medical surgery, wireless terminal in smart grid, wireless terminal in transportation safety, wireless terminal in smart city, and wireless terminal in smart home having a function of wireless transceiving, etc. The specific technology and the specific device form employed by the terminal 102 are not limited in the example of the disclosure.

It is to be noted that the technical solution in the example of the disclosure may be applied to various communication systems, for example, a long term evolution (LTE) system, a 5th generation (5G) mobile communication system, a 5G new radio (NR) system, or other future novel mobile communication systems, etc. It is also to be noted that a side link in the example of the disclosure may also be referred to as a sidelink.

It is to be understood that the communication system described in the example of the disclosure is intended to describe the technical solution in the example of the disclosure more clearly, instead of limiting the technical solution disclosed in the example of the disclosure. As those of ordinary skill in the art know, with evolution of the system architecture and emergence of new service scenario, the technical solution according to the example of the disclosure is also applicable to similar technical problems.

In related art, a demodulation reference signal (DMRS) is transmitted by a NR PDCCH on a resource element (RE) occupied with transmission of an LTE CRS. With one slot including 14 OFDM symbols as an example, the LTE CRS supports 4 ports, and the CRS occupies 6 OFDM symbols in one slot in this case. Thus, the NR PDCCH may perform transmission on 8 remaining OFDM symbols only, and cannot perform transmission by using a control resource set (CORESET) having a duration of 3 consecutive symbols. Accordingly, a capacity and transmission performance of the NR PDCCH are severely restricted.

Moreover, for a single-transmission reception point (TRP) physical downlink shared channel (PDSCH), an existing mechanism supports the PDSCH in performing a rate-matching pattern on one LTE CRS pattern. Two TRPs support two LTE CRS rate-matching patterns, and indicate different rate-matching patternlists based on different TRPs.

If the terminal is configured by higher layer parameter PDCCH-Config with two different values of coresetPoolIndex in ControlResourceSet and is also configured by the higher layer parameter lte-CRS-PatternList1-r16 and lte-CRS-PatternList2-r16 in ServingCellConfig, the following REs are declared as not available for PDSCH:
if the UE is configured with crs-RateMatch-PerCoresetPoolIndex, REs indicated by the CRS pattern(s) in lte-CRS-PatternList1-r16 if the PDSCH is associated with coresetPoolIndex set to ‘0’, or the CRS pattern(s) in lte-CRS-PatternList2-r16 if PDSCH is associated with coresetPoolIndex set to ‘1’;
otherwise, REs indicated by lte-CRS-PatternList1-r16 and lte-CRS-PatternList2-r16, in ServingCellConfig.

Considering that in a single-TRP scenario, a terminal in an edge cell may be interfered by CRSs of one or more neighboring cells. If the PDCCH performs puncturing around the RE where the CRS is located, a much smaller number of REs will be available for transmitting the PDCCH. If a terminal is interfered by CRSs of two cells, a possibility of collision with PDCCH transmission may be increased, and transmission performance of the PDCCH is further reduced.

In view of the above, a DMRS transmission method is provided. For a terminal interfered by CRSs of one or more cells, an additional DMRS is introduced, and the NR PDCCH still transmits the additional DMRS on the RE occupied with transmission of the LTE CRS. The additional DMRS being transmitted on the RE occupied with the transmission of the CRS may improve the capacity of the NR PDCCH and may improve the transmission performance.

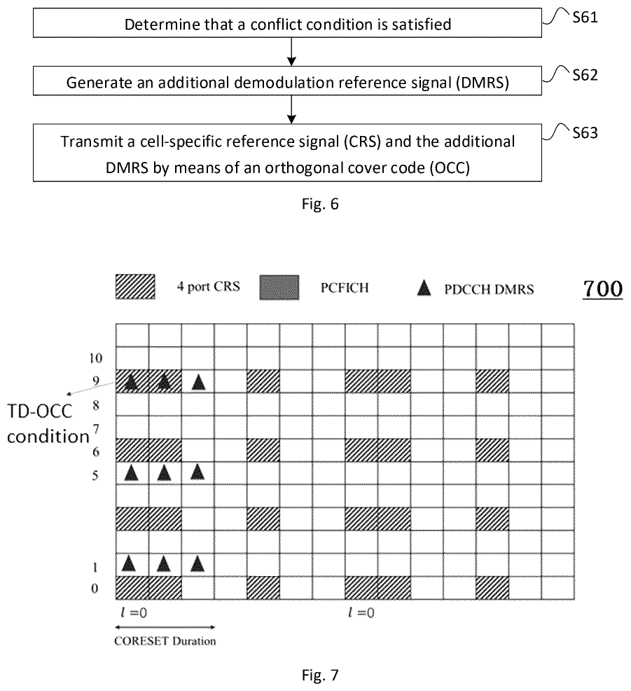

With reference to FIG. 6, FIG. 6 is a flowchart of a demodulation reference signal (DMRS) transmission method according to an example of the disclosure.

As shown in FIG. 6, the DMRS transmission method is performed by a network device and may include, but is not limited to, steps S61, S62 and S63.

Step S61 includes determining that a collision condition is satisfied.

Step S62 includes generating an additional DMRS.

Step S63 includes transmitting a cell-specific reference signal (CRS) and the additional DMRS by means of an orthogonal cover code (OCC).

In some examples, the collision condition includes at least one of an orthogonal cover code of time domain (TD-OCC) condition or an orthogonal cover code of frequency domain (FD-OCC) condition.

In some examples, the TD-OCC condition is as follows: a first DMRS of a physical downlink control channel (PDCCH) conflicts with a CRS on a resource element (RE), and first DMRSs on two consecutive orthogonal frequency division multiplexing (OFDM) symbols corresponding to an index of the RE both conflict with the CRS.

It can be understood that in a case of determining that the first DMRS of the PDCCH conflicts with the CRS on the RE, the network device determines that the first DMRSs on the two consecutive OFDM symbols corresponding to the index of the RE both conflict with the CRS. In this case, it is determined that the collision condition, i.e. the TD-OCC condition is satisfied.

In an example schedule 700, as shown in FIG. 7, the slash shaded part denotes a position of an OFDM symbol corresponding to the CRS, and the triangular identifier part denotes a position of an OFDM symbol corresponding to the first DMRS. An OFDM symbol 9 satisfies the TD-OCC condition in a case that the OCC condition is the TD-OCC condition, the LTE CRS supports 4 ports, and the cell-level symbol shift ν_{shift}=0.

In the example of the disclosure, as shown in FIG. 7, the RE 9 satisfies the TD-OCC condition, and the first DMRSs on two consecutive OFDM symbols corresponding to the RE 9 both conflict with the CRS.

In some examples, the FD-OCC condition is as follows: a first DMRS of a PDCCH conflicts with the CRS on a RE, and two consecutive first DMRSs on a same OFDM symbol corresponding to the RE both conflict with the CRS.

It can be understood that in a case of determining that the first DMRS of the PDCCH conflicts with the CRS on the RE, the network device determines that two consecutive first DMRSs on a same OFDM symbol corresponding to the RE both conflict with the CRS. In this case, it is determined that the collision condition, i.e., the FD-OCC condition is satisfied.

In the example of the disclosure, in a case that the NR shares a spectrum resource with the LTE, if a time domain resource occupied by the first DMRS and a time domain resource occupied by the CRS are both RE, the first DMRS conflicts with the CRS on the RE.

In some examples, the first DMRS and the additional DMRS of the PDCCH belong to a NR system, and the CRS belongs to an LTE system.

It is to be noted that the first DMRS of the PDCCH may be transmitted by, for example, a gNB in the NR system, and the CRS may be transmitted by, for example, an eNB in the LTE system. In the example of the disclosure, the first DMRS and the additional DMRS of the PDCCH belong to the NR system, and the CRS belongs to the LTE system.

In the example of the disclosure, the RE configured to transmit the CRS is determined. In a case that it is determined that the RE satisfies the OCC condition, the additional DMRS is generated, and the additional DMRS is transmitted on the RE by means of the OCC.

In the example of the disclosure, the network device forgoes transmitting the first DMRS on the RE in a case of determining that the collision condition is satisfied.

Alternatively, in a case of determining that the collision condition is satisfied, the network device generates the additional DMRS, forgoes transmitting the first DMRS, and transmits the additional DMRS on the RE.

Alternatively, in a case of determining that the collision condition is satisfied, the network device determines a position of a shifted RE by means of shifting in the frequency domain, and transmits the first DMRS at the position of the shifted RE, and so on. The operation of the network device in a case of determining that the collision condition is satisfied is not limited in the example of the disclosure.

In the example of the disclosure, in a case of determining that the collision condition is satisfied, the network device forgoes transmitting the first DMRS on the RE; and alternatively, determines the position of the shifted RE by means of shifting in the frequency domain and transmits the first DMRS at the position of the shifted RE. Alternatively, the additional DMRS is generated, and the additional DMRS is transmitted on the RE where the first DMRS conflicts with the CRS.

The additional DMRS is different from the first DMRS. The additional DMRS may be transmitted on two REs consecutive in the time domain and occupied with transmission of the CRS, and a symbol for transmission of the additional DMRS is associated with a CRS symbol corresponding to the RE where the conflict occurs.

In some examples, a mode of the OCC includes at least one of a TD-OCC mode or a FD-OCC mode.

In the example of the disclosure, the CRS and the additional DMRS are simultaneously transmitted on the RE by means of the OCC. The CRS and the additional DMRS may be simultaneously transmitted on the RE by means of the TD-OCC. Alternatively, the CRS and the additional DMRS may be simultaneously transmitted on the RE by means of the FD-OCC. Alternatively, the CRS and the additional DMRS may be simultaneously transmitted on the RE by means of the TD-OCC and the FD-OCC. Thus, the CRS and the additional DMRS are simultaneously transmitted on the RE, so that a capacity of the NR PDCCH can be improved and transmission performance can be improved.

In some examples, the additional DMRS transmitted on an antenna port p, a sub-carrier k, and an OFDM symbol/satisfies conditions as follows:

a_{k,l}^{(p,μ)}=β_{DMRS}^{PDCCH}ω_{f}(k′)ωₜ(l′)r_{k,l}^{(dmrs)},k′=0,1, and l′=0,1,

where β_{DMRS}^{PDCCH} denotes a transmission power parameter for the additional DMRS, p=2000 denotes the antenna port, μ denotes sub-carrier spacing (SCS), k denotes a sub-carrier index, ω_{f} denotes a function, ωₜ denotes a function, and l denotes an intra-slot symbol index;
in a case that the mode of the OCC is the TD-OCC mode, ω_{f}(k′)=1, ωₜ(0)=−1, ωₜ(1)=1, and l′=0, 1 denotes two consecutive OFDM symbols where a CRS symbol corresponding to a same RE index corresponding to a target CRS pattern is located in a case that the TD-OCC condition is satisfied; and
in a case that the mode of the OCC is the FD-OCC mode, ω_{f}(0)=−1, ω_{f}(1)=1, ωₜ(l′)=1, and k′=0, 1 denotes a RE index corresponding to two consecutive CRS symbols corresponding to a same OFDM symbol index corresponding to a target CRS pattern in a case that the FD-OCC condition is satisfied.

In the example of the disclosure, orthogonally multiplexing of the RE by the additional DMRS and the CRS may be realized by using the TD-OCC mode or the FD-OCC mode. Whether the TD-OCC mode or the FD-OCC mode is selected may be determined through signaling indication.

It can be understood that the target CRS pattern may be one or more CRS patterns, where different CRS patterns correspond to different CRSs. The CRS corresponding to the CRS pattern conflicts with the first DMRS on the RE.

In some examples, the target CRS pattern corresponds to a CRS pattern 1, and/or the target CRS pattern corresponds to a CRS pattern 2, where the CRS pattern 1 and the CRS pattern 2 are configured to indicate the CRSs corresponding to different CRS patterns.

In the example of the disclosure, the target CRS pattern corresponds to the CRS pattern 1. Alternatively, the target CRS pattern corresponds to the CRS pattern 2. Alternatively, the target CRS pattern corresponds to the CRS pattern 1 and the CRS pattern 2. Where the CRS pattern 1 and the CRS pattern 2 are configured to indicate the CRSs corresponding to different CRS patterns. The CRS corresponding to the CRS pattern conflicts with the first DMRS on the RE.

In some examples, the CRS is determined by the target CRS pattern, and the symbol of the additional DMRS is associated with the CRS encountering the conflict, where:
r_{k,l}^{(dmrs)}=r_{l,n}_{ₛ}^{(crs,i)}(m), where i denotes an index of the target CRS pattern, and i=1 and/or i=2; and
r_{l,n}_{ₛ}^{(crs,i)}(m) denotes a CRS symbol corresponding to a CRS pattern i, the CRS symbol is transmitted on a slot nₛ, the OFDM symbol l, and the sub-carrier k, and the sub-carrier index k corresponds to m.
   Where k=6m+(v+v_{shift}) mod 6, m=0, 1, . . . , 2*N_{RB}^{DL}−1. Reference may be made to the description in the background of the invention for the meaning of v_{shift} and N_{RB}^{DL}.

In the example of the disclosure, the network device determines the target CRS pattern according to the CRS pattern index i, so as to determine the CRS according to the target CRS pattern. In a case of determining that the index i of the target CRS pattern is n, the target CRS pattern is determined to be CRS pattern n. For example, in a case of determining that the index i of the target CRS pattern is 1, the target CRS pattern is determined to be the CRS pattern 1. Alternatively, in a case of determining that the index i of the target CRS pattern is 2, the target CRS pattern is determined to be the CRS pattern 2. Alternatively, in a case of determining that the indexes i of the target CRS pattern are 1 and 2, the target CRS pattern is determined to be the CRS pattern 1 and the CRS pattern 2.

The index i of the target CRS pattern may be determined by the network device in a predefined manner or through signaling indication. One possible predefined rule is as follows: different CRS pattern lists are defined, and a target CRS pattern list is associated with the target CRS pattern. For example, different CRS pattern lists, i.e. lte-CRS-PatternList1-r18 and lte-CRS-PatternList2-r18 are defined, where lte-CRS-PatternList1-r18 is associated with the target CRS pattern, and lte-CRS-PatternList2-r18 is associated with other CRS patterns.

In some examples, an indication instruction is transmitted to the terminal by the network device. The indication instruction is configured to indicate the target CRS pattern, so as to inform the terminal of simultaneously transmission of the CRS and the additional DMRS by means of the OCC on the RE configured to transmit the CRS corresponding to the target CRS pattern.

For ease of understanding, an example is provided.

In the example, as shown in FIG. 7, an RE on an OFDM symbol 0 and an OFDM symbol 1 corresponding to an RE index 9 satisfies the TD-OCC condition, in a case that the OCC condition is the TD-OCC condition, the LTE CRS supports 4 ports, and the cell-level symbol shift v_{shift}=0.

In the example of the disclosure, the first DMRS of the NR PDCCH conflicts with the LET CRS on the RE 9, and the network device may forgo transmitting the first DMRS on the RE, and transmit other DMRSs, for example, the additional DMRS (indicated by triangular identifiers in the RE 9 in FIG. 7). The network device simultaneously transmits the additional DMRS and the CRS by means of the OCC in a case of determining that the RE satisfies the OCC condition.

Alternatively, the network device may forgo transmitting the first DMRS on the RE, determine a position of a shifted RE by means of shifting in the frequency domain, and transmit the first DMRS at the position of the shifted RE. For example, the network device determines the positions of the shifted REs (indicated by the triangular identifiers in RE 1 and RE 5 in FIG. 7) by means of shifting in the frequency domain, and transmits the first DMRS on other REs (the RE 1 and the RE 5 in FIG. 7) other than the RE.

Alternatively, the network device may forgo transmitting the first DMRS in a case of determining that the RE satisfies the OCC condition, and so on. The operation of the network device in a case of determining that the collision condition is satisfied is not limited in the example of the disclosure

In the example of the disclosure, considering that the DMRS is transmitted on REs corresponding to indexes {1, 5, 9}, a position at which the additional DMRS of the NR PDCCH is transmitted in one resource block (RB) may be an index of corresponding RE satisfying at least one of the TD-OCC condition or the FD-OCC condition in an RE set {1, 5, 9}. The RE set {1, 5, 9} may be positions of REs corresponding to the first DMRS, and may also be indexes of any corresponding REs satisfying at least one of the TD-OCC condition or the FD-OCC condition. A possible RE set and REs satisfying at least one of the TD-OCC condition or the FD-OCC condition may also be predefined or indicated through signaling.

As shown in FIG. 7, the additional DMRS is transmitted on corresponding RE (k, l) satisfying the TD-OCC condition. In a case that the target CRS pattern includes the CRS pattern 1 and the CRS pattern 2, symbol corresponding to the additional DMRS satisfies at least one of the following:
the target CRS pattern corresponds to a CRS pattern 1, or
the target CRS pattern corresponds to a CRS pattern 2,
where the CRS pattern 1 and the CRS pattern 2 are configured to indicate CRSs corresponding to different CRS patterns.
r_{k,l}^{(dmrs)}=r_{l,n}_{ₛ}^{(crs,i)}(m), where i denotes an index of the target CRS pattern, and i=1 and/or i=2; and
r_{l,n}_{ₛ}^{(crs,i)}(m) denotes a CRS symbol corresponding to a CRS pattern i, the CRS symbol is transmitted on a slot nₛ, the OFDM symbol l, and the sub-carrier k, and the sub-carrier index k corresponds to m.
   Where k=6m+(v+v_{shift}) mod 6, m=0, 1, . . . , 2*N_{RB}^{DL}−1. Reference may be made to the description for the meaning of v_{shift} and N_{RB}^{DL}.

Then, resource mapping is performed on the symbol of the additional DMRS.

The additional DMRS mapped to a resource (k, l) p, satisfies conditions as follows:

a_{k,l}^{(p,μ)}=β_{DMRS}^{PDCCH}ω_{f}(k′)ωₜ(l′)r_{k,l}^{(dmrs)},k′=0,1, and l′=0,1,
where β_{DMRS}^{PDCCH} denotes a transmission power parameter for the additional DMRS, an antenna port p=2000, μ denotes sub-carrier spacing (SCS), k denotes a sub-carrier index, and l denotes an intra-slot symbol index;
in a case that the mode of the OCC is the TD-OCC mode, ω_{f}(k′)=1, ωₜ(0)=1, ωₜ(1)=−1, and l′=0, 1 denotes two consecutive OFDM symbols where a CRS symbol corresponding to a same RE index corresponding to a target CRS pattern is located in a case that the TD-OCC condition is satisfied; and
in a case that the mode of the OCC is the FD-OCC mode, ω_{f}(0)=1, ω_{f}(1)=−1, ωₜ(l′)=1, and k′=0, 1 denotes an RE index corresponding to two consecutive CRS symbols corresponding to a same OFDM symbol index corresponding to a target CRS pattern in a case that the FD-OCC condition is satisfied.

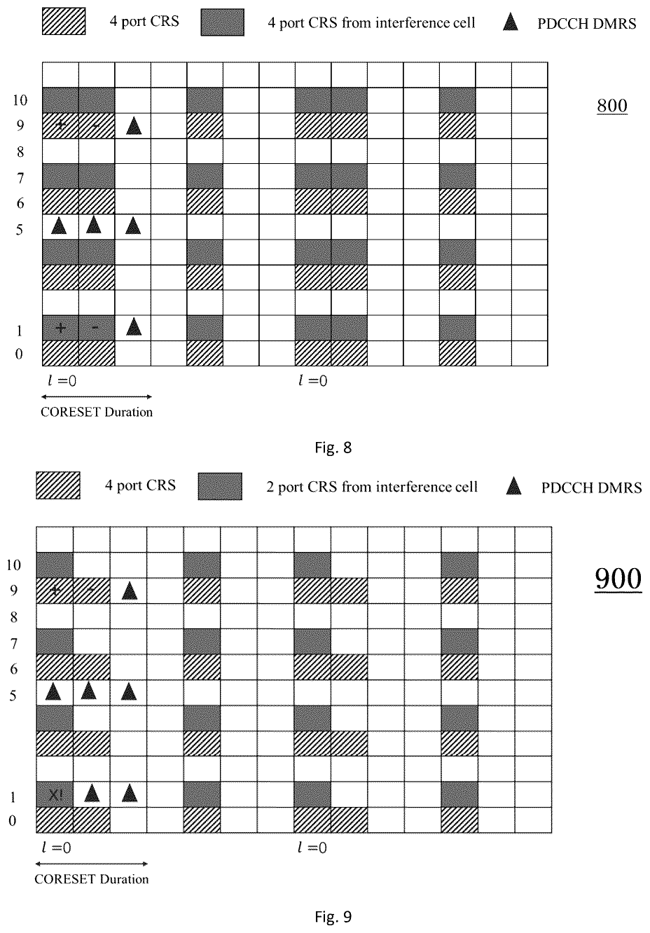

In an example, an implementation scenario is shown in example schedules 800 and 900 in FIG. 8 and FIG. 9 (respectively), where + corresponds to ωₜ(0)=1, and − corresponds to ωₜ(1)=−1. In addition to the solution in FIG. 7, values may also be set as follows in a case that the mode of OCC is the TD-OCC mode: ω_{f}(k′)=1, ωₜ(0)=−1, ωₜ(1)=1, and l′=0, 1 denotes two consecutive OFDM symbols where a CRS symbol corresponding to a same RE index corresponding to the target CRS pattern is located in a case that the TD-OCC condition is satisfied; and
values may also be set as follows in a case that the mode of OCC is the FD-OCC mode: ω_{f}(0)=−1, ω_{f}(1)=1, ωₜ(l′)=1, and k′=0, 1 denotes an RE index corresponding to two consecutive CRS symbols corresponding to a same OFDM symbol index corresponding to the target CRS pattern in a case that the FD-OCC condition is satisfied.

In the example, the network device implements orthogonal multiplexing of the RE with the CRS by generating the additional DMRS. Thus, a number of REs available for transmission of the PDCCH can be increased, and transmission efficiency of the PDCCH can be effectively improved, while channel estimation performance of the PDCCH can be effectively improved.

For ease of understanding, another example is provided.

In the example of the disclosure, a CRS pattern corresponding to a CRS orthogonally multiplexing of an RE with an additional DMRS is determined by the network device, and transmitted to the terminal through signaling indication. Alternatively, a CRS pattern corresponding to a CRS orthogonally multiplexing of an RE with an additional DMRS is determined in a predefined manner. For example, lte-CRS-PatternList1-r18 is defined to be associated with a CRS pattern corresponding to a CRS orthogonally multiplexing of an RE with an additional DMRS, and lte-CRS-PatternList2-r18 is defined to be associated with a CRS pattern corresponding to other CRSs.

In this scenario, a CRS satisfying the TD-OCC condition belongs to the CRS pattern defined by lte-CRS-PatternList1-r18. In this scenario, the additional DMRS performs orthogonal multiplexing of an RE with the CRS corresponding to the CRS pattern defined by lte-CRS-PatternList1-r18 through a TD-OCC or an FD-OCC.

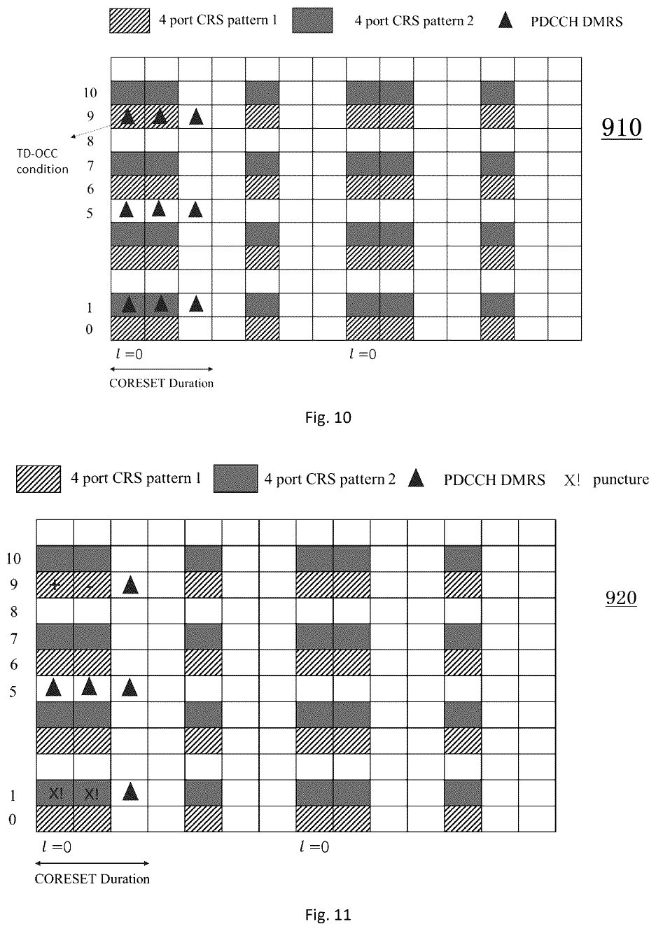

In an example, as shown in an example schedule 910 as shown in FIG. 10, the OCC condition is the TD-OCC condition. In a case of the CRS pattern of two 4-port CRSs, and a cell-level symbol shift v_{shift}=0, the TD-OCC condition is satisfied on an RE 9 at the OFDM symbol 0 and the OFDM symbol 1.

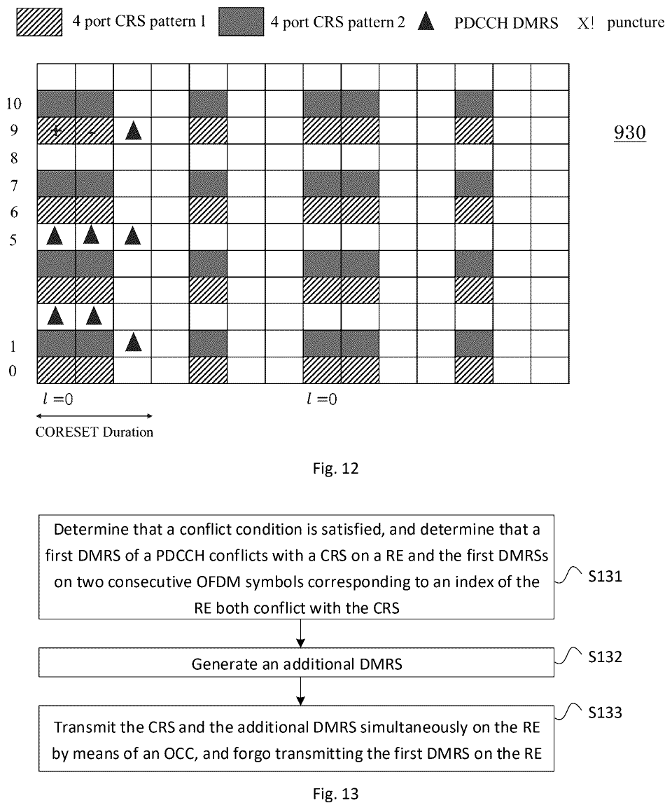

In the example of the disclosure, the network device determines that a conflict condition is satisfied, determines that a first DMRS of a PDCCH conflicts with a CRS on an RE, and first DMRSs on two consecutive OFDM symbols corresponding to an index of the RE both conflict with the CRS and/or two consecutive first DMRSs on a same OFDM symbol corresponding to the RE both conflict with the CRS, generates an additional DMRS and simultaneously transmits the CRS and the additional DMRS on the RE by means of the OCC. The additional DMRS may perform orthogonal multiplexing of the RE with the CRS by means of the TD-OCC. The definition of the first DMRS and a manner of resource mapping are the same as those in the above-mentioned examples, and will not be repeated. In a case that the CRS does not belong to lte-CRS-PatternList1-r18 and conflicts with the first DMRS, corresponding first DMRS may be punctured, and the network device forgoes transmitting the first DMRS. An illustrative implementation scenario is shown in an example schedule 920 in FIG. 11. The first DMRS may also be shifted to other positions in the frequency domain for transmission by means of shifting in the frequency domain, and an illustrative implementation scenario is shown in an example schedule 930 in FIG. 12.

In an embodiment, the additional DMRS performs orthogonal multiplexing of an RE with a target CRS. In this scenario, the target CRS is defined as a CRS satisfying the FD-OCC condition. The RE corresponding to the FD-OCC condition may be defined as an RE corresponding to a CRS that belongs to a specific CRS pattern and conflicts with two consecutive DMRSs.

The way in which the additional DMRS performs orthogonal multiplexing of the RE with the CRS by means of at least one of the TD-OCC mode or the FD-OCC mode, and the selection of at least one of the TD-OCC mode or the FD-OCC mode may be determined based on channel time-varying characteristics, etc., which is not limited in the disclosure. The selection of at least one of the TD-OCC mode or the FD-OCC mode may be indicated to the terminal through signaling, and may also be determined in a predefined manner based on the channel time-varying characteristics, etc.

The additional DMRS is transmitted on corresponding RE (k, l) satisfying the TD-OCC condition. In a case that the target CRS pattern includes a CRS pattern 1 and a CRS pattern 2, a symbol corresponding to the additional DMRS satisfies a condition as follows:
r_{k,l}^{(dmrs)}=r_{l,n}_{ₛ}^{(crs,i)}(m), where i denotes an index of the target CRS pattern, and i=1 and/or i=2; and
r_{l,n}_{ₛ}^{(crs,i)}(m) denotes a CRS symbol corresponding to a CRS pattern i, the CRS symbol is transmitted on a slot nₛ, the OFDM symbol l, and the sub-carrier k, and the sub-carrier index k corresponds to m.
   Where k=6m+ (v+v_{shift}) mod 6, m=0, 1, . . . , 2*N_{RB}^{DL}−1. Reference may be made to the description above for the meanings of v_{shift} and N_{RB}^{DL}.

Then, resource mapping is performed on the symbol of the additional DMRS.

The additional DMRS mapped to a resource (k, l)_{p,μ} satisfies conditions as follows:

a_{k,l}^{(p,μ)}=β_{DMRS}^{PDCCH}ω_{f}(k′)ωₜ(l′)r_{k,l}^{(dmrs)},k′=0,1, and l′=0,1,
where β_{DMRS}^{PDCCH} denotes a transmission power parameter for the additional DMRS, an antenna port p=2000, μ denotes sub-carrier spacing (SCS), k denotes a sub-carrier index, and l denotes an intra-slot symbol index;
in a case that the mode of OCC is the TD-OCC mode, ω_{f}(k′)=1, ωₜ(0)=1, ωₜ(1)=−1, and l′=0, 1 denotes two consecutive OFDM symbols where a CRS symbol corresponding to a same RE index corresponding to a target CRS pattern is located in a case that the TD-OCC condition is satisfied; and
in a case that the mode of OCC is the FD-OCC mode, ω_{f}(0)=1, ω_{f}(1)=−1, ωₜ(l′)=1, and k′=0, 1 denotes an RE index corresponding to two consecutive CRS symbols corresponding to a same OFDM symbol index corresponding to a target CRS pattern in a case that the FD-OCC condition is satisfied.

Values may also be set as follows in a case that the mode of OCC is the TD-OCC mode: ω_{f}(k′)=1, ωₜ(0)=−1, ωₜ(1)=1, and l′=0, 1 denotes two consecutive OFDM symbols where a CRS symbol corresponding to a same RE index corresponding to the target CRS pattern is located in a case that the TD-OCC condition is satisfied; and
values may also be set as follows in a case that the mode of OCC is the FD-OCC mode: ω_{f}(0)=−1, ω_{f}(1)=1, ωₜ(l′)=1, and k′=0, 1 denotes an RE index corresponding to two consecutive CRS symbols corresponding to a same OFDM symbol index corresponding to the target CRS pattern in a case that the FD-OCC condition is satisfied.

In the example, the network device determines the CRS pattern and the CRS corresponding to the CRS pattern. Thus, the interference to the LTE CRS can be reduced as much as possible, and transmission performance of the PDCCH can be effectively improved, so that the balance between transmission performance of the PDCCH and transmission performance of the LTE CRS can be realized.

For ease of understanding, yet another example is provided.

In the example of the disclosure, the network device may flexibly select different mechanisms to process the scenario where a first DMRS conflicts with a CRS. In a case that the NR shares a spectrum resource with the LTE, if a time domain resource occupied by the first DMRS and a time domain resource occupied by the CRS are both resource element (RE), the first DMRS conflicts with the CRS on the RE. The additional DMRS is different from the first DMRS. A symbol of the additional DMRS is associated with a CRS symbol encountering the conflict, and the additional DMRS may be transmitted on two REs consecutive in the time domain and occupied with transmission of the CRS.

In a case of processing the scenario where the first DMRS conflicts with the CRS, the network device may flexibly select one or more different mechanisms.

Mechanism 1: in a case that the first DMRS conflicts with the CRS, a corresponding symbol of the first DMRS is punctured, and neither the first DMRS nor the additional DMRS is transmitted.

Mechanism 2: in a case that the first DMRS conflicts with the CRS, the first DMRS is transmitted at a position of a shifted RE determined by shifting in the frequency domain, and no additional DMRS is transmitted.

Mechanism 3: in a case that the first DMRS conflicts with the CRS, the additional DMRS is transmitted on the RE, a corresponding symbol of the first DMRS is punctured, and the first DMRS does not be transmitted.

Mechanism 4: in a case that the first DMRS conflicts with the CRS, the additional DMRS is transmitted on the RE, and the first DMRS is transmitted at a position of a shifted RE determined by shifting in the frequency domain.

It is to be noted that the network device may decide to select the mechanism independently, determine the mechanism to be used in a predefined manner, or determine the mechanism to be used through signaling indication.

In an example, the predefined manner is employed. For example, in a case that the first DMRS conflicts with the CRS on only one OFMD symbol of the RE, the mechanism 1 is employed. Alternatively, in a case that the first DMRS conflicts with the CRS on a plurality of OFMD symbols of the RE, the mechanism 2 is employed. Alternatively, in a case that the first DMRS conflicts with the CRS on a plurality of OFMD symbols of the RE, the mechanism 4 is employed, and so on. It is to be noted that the instances are illustrative, and do not limit the example of the disclosure.

In the example of the disclosure, in a case of determining the mechanism to be selected, the network device may transmit indication information to the terminal, so as to notify the terminal of the mechanism selected by the network device for transmitting the first DMRS and the CRS in a case of the network device processing a scenario where the first DMRS conflicts with the CRS.

In the example of the disclosure, the network device determines that the conflict condition is satisfied; generates the additional DMRS; and transmits the CRS and the additional DMRS by means of the OCC. Thus, the additional DMRS of the NR PDCCH and the CRS are transmitted by means of the OCC, and the additional DMRS is transmitted on a resource occupied by the CRS. Accordingly, a capacity of the NR PDCCH can be improved and transmission performance can be improved.

With reference to FIG. 13, FIG. 13 is a flowchart of another demodulation reference signal (DMRS) transmission method according to an example of the disclosure.

As shown in FIG. 13, the DMRS transmission method is performed by a network device and may include, but is not limited to, steps S131, S132 and S133.

Step S131 includes determining that a conflict condition is satisfied; and determining that a first DMRS of a PDCCH conflicts with a CRS on an RE and the first DMRSs on two consecutive OFDM symbols corresponding to an index of the RE both conflict with the CRS.

Step S132 includes generating an additional DMRS.

Step S133 includes simultaneously transmitting the CRS and the additional DMRS on the RE by means of an OCC, and forgoing transmitting the first DMRS on the RE.

Reference may be made to relevant description in the above-mentioned examples for the relevant description that the network device determines that the collision condition is satisfied, which will not be repeated.

Reference may be made to the relevant description in the above-mentioned examples for the relevant description that in a case that the network device determines that the first DMRS of the PDCCH conflicts with the CRS on the RE and the first DMRSs on two consecutive OFDM symbols corresponding to the index of the RE both conflict with the CRS, the network device generates the additional DMRS, and simultaneously transmits the CRS and the additional DMRS on the RE by means of the OCC, which will not be repeated.

In the example of the disclosure, in a case that the network device determines that the first DMRS of the PDCCH conflicts with the CRS on the RE and the first DMRSs on two consecutive OFDM symbols corresponding to the index of the RE both conflict with the CRS, the network device generates the additional DMRS, simultaneously transmits the CRS and the additional DMRS on the RE by means of the OCC, and forgoes transmitting the first DMRS.

Reference may be made to the relevant description in the above-mentioned examples, and the same contents will not be repeated. The effects obtained in the example of the disclosure are identical to those obtained in the above-mentioned examples, and reference may be made to the relevant description in the above-mentioned examples for details.

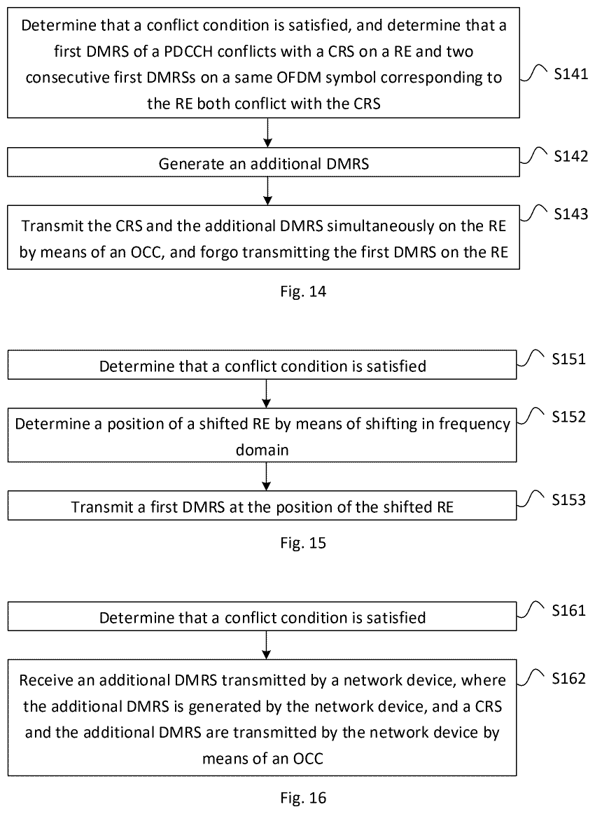

With reference to FIG. 14, FIG. 14 is a flowchart of yet another demodulation reference signal (DMRS) transmission method according to an example of the disclosure.

As shown in FIG. 14, the DMRS transmission method is performed by a network device and may include, but is not limited to, steps S141, S142 and S143.

Step S141 includes determining that a conflict condition is satisfied; and determining that a first DMRS of a PDCCH conflicts with a CRS on a RE, and two consecutive first DMRSs on a same OFDM symbol corresponding to the RE both conflict with the CRS.

Step S142 includes generating an additional DMRS.

Step S143 includes simultaneously transmitting the CRS and the additional DMRS on the RE by means of an OCC, and forgoing transmitting the first DMRS on the RE.

Reference may be made to the relevant description in the above-mentioned examples for the relevant description that the network device determines that the conflict condition is satisfied, which will not be repeated.

Reference may be made to the relevant description in the above-mentioned examples for the relevant description that in a case that the network device determines that the first DMRS of the PDCCH conflicts with the CRS on the RE and two consecutive first DMRSs on a same OFDM symbol corresponding to the RE both conflict with the CRS, the network device generates the additional DMRS and simultaneously transmits the CRS and the additional DMRS on the RE by means of the OCC, which will not be repeated.

In the example of the disclosure, in a case that the network device determines that the first DMRS of the PDCCH conflicts with the CRS on the RE and two consecutive first DMRSs on a same OFDM symbol corresponding to the RE both conflict with the CRS, the network device generates the additional DMRS, simultaneously transmits the CRS and the additional DMRS on the RE by means of the OCC, and forgoes transmitting the first DMRS.

Reference may be made to the relevant description in the above-mentioned examples, and the same contents will not be repeated. The effects obtained in the example of the disclosure are identical to those obtained in the above-mentioned examples, and reference may be made to the relevant description in the above-mentioned examples for details.

With reference to FIG. 15, FIG. 15 is a flowchart of yet another demodulation reference signal (DMRS) transmission method according to an example of the disclosure.

As shown in FIG. 15, the DMRS transmission method is performed by a network device and may include, but is not limited to, steps S151, S152 and S153.

Step S151 includes determining that a conflict condition is satisfied.

Step S152 includes determining a position of a shifted RE by means of shifting in frequency domain.

Step S153 includes transmitting a first DMRS at the position of the shifted RE.

In some examples, the conflict condition includes at least one of an orthogonal cover code of time domain (TD-OCC) condition or an orthogonal cover code of frequency domain (FD-OCC) condition.

In some examples, the TD-OCC condition is as follows: first DMRSs on two consecutive OFDM symbols corresponding to the RE both conflict with the CRS.

In some examples, the FD-OCC condition is as follows: two consecutive first DMRSs on a same OFDM symbol corresponding to the RE both conflict with the CRS.

Reference may be made to the relevant description in the above-mentioned examples for the relevant description that the first DMRS of a PDCCH conflicts with the CRS on the RE, which will not be repeated.

In the example of the disclosure, in a case of determining that the conflict condition is satisfied, the network device determines the position of the shifted RE by means of shifting in the frequency domain, and transmits the first DMRS at the position of the shifted RE.

It is to be noted that determining by the network device the position of the shifted RE by means of shifting in the frequency domain may be realized through the following manner: taking an RE corresponding to the first DMRS as an initial position, shifting in a direction of at least one of an increasing or decreasing in the frequency domain, and determining an RE not transmitting CRSs and having a smallest frequency domain spacing with the RE at the initial position as the position of the shifted RE.

Reference may be made to the relevant description in the above-mentioned examples, and the same contents will not be repeated. The effects obtained in the example of the disclosure are identical to those obtained in the above-mentioned examples, and reference may be made to the relevant description in the above-mentioned examples for details.

With reference to FIG. 16, FIG. 16 is a flowchart of yet another demodulation reference signal (DMRS) transmission method according to an example of the disclosure.

As shown in FIG. 16, the DMRS transmission method is performed by a terminal and may include, but is not limited to, steps S161 and S162.

Step S161 includes determining that a conflict condition is satisfied.

Step S162 includes receiving an additional DMRS transmitted by ta network device, where the additional DMRS is generated by the network device, and a cell-specific reference signal (CRS) and the additional DMRS are transmitted by the network device by means of an orthogonal cover code (OCC).

In some examples, the conflict condition includes at least one of an orthogonal cover code of time domain (TD-OCC) condition or an orthogonal cover code of frequency domain (FD-OCC) condition.

In some examples, the TD-OCC condition is as follows: a first DMRS of a physical downlink control channel (PDCCH) conflicts with the CRS on a resource element (RE), and the first DMRSs on two consecutive orthogonal frequency division multiplexing (OFDM) symbols corresponding to an index of the RE both conflict with the CRS.

It can be understood that determining by the terminal that the conflict condition is satisfied may include: determining that the first DMRS of the PDCCH conflicts with the CRS on the RE, and that the first DMRSs on two consecutive OFDM symbols corresponding to the index of the RE both conflict with the CRS.

In some examples, the FD-OCC condition is as follows: a first DMRS of a PDCCH conflicts with the CRS on a RE, and two consecutive first DMRSs on a same OFDM symbol corresponding to the RE both conflict with the CRS.

It can be understood that determining by the terminal that the conflict condition is satisfied may include: determining that the first DMRS of the PDCCH conflicts with the CRS on the RE, and that two consecutive first DMRSs on a same OFDM symbol corresponding to the RE both conflict with the CRS.

In the example of the disclosure, in a case that the NR shares a spectrum resource with the LTE, if a time domain resource occupied by the first DMRS and a time domain resource occupied by the CRS are both RE, the first DMRS conflicts with the CRS on the RE.

In some examples, the first DMRS and the additional DMRS of the PDCCH belong to a NR system, and the CRS belongs to an LTE system.

It is to be noted that the first DMRS and the additional DMRS of the PDCCH may be transmitted by, for example, a gNB in the NR system, and the CRS may be transmitted by, for example, an eNB in the LTE system. In the example of the disclosure, the first DMRS and the additional DMRS of the PDCCH belong to the NR system, and the CRS belongs to the LTE system.

In the example of the disclosure, the RE configured to transmit the CRS is determined by the terminal. In a case that it is determined that the RE satisfies the OCC condition, the additional DMRS is received on the RE, where the additional DMRS is generated by the network device.

In the example of the disclosure, the terminal forgoes receiving the first DMRS on the RE in a case of determining that the conflict condition is satisfied, and thus cannot receive the first DMRS.

Alternatively, the terminal receives the additional DMRS on the RE in a case of determining that the conflict condition is satisfied.

Alternatively, in a case of determining that the conflict condition is satisfied, the terminal receives the additional DMRS on the RE and forgoes receiving the first DMRS on the RE.

Alternatively, in a case of determining that the conflict condition is satisfied, the terminal receives the additional DMRS on the RE, determines a position of a shifted RE by means of shifting in frequency domain, and receives the first DMRS at the position of the shifted RE. That is, the terminal receives the first DMRS at the position of the shifted RE.

Alternatively, in a case of determining that the conflict condition is satisfied, the terminal determines a position of a shifted RE by means of shifting in frequency domain, and receives the first DMRS at the position of the shifted RE, and so on. The operation of the terminal in a case of determining that the collision condition is satisfied is not limited in the example of the disclosure.

In some examples, a mode of the OCC includes at least one of a TD-OCC mode or a FD-OCC mode.

In the example of the disclosure, the terminal receives the additional DMRS on the RE in a case of determining that the conflict condition is satisfied; alternatively, in a case of determining that the RE satisfies the OCC condition, the terminal receives the additional DMRS on the RE, or the CRS and the additional DMRS may be simultaneously transmitted on the RE by means of the TD-OCC mode and the FD-OCC mode; alternatively, the terminal receives the additional DMRS on the RE in a case of determining that the RE satisfies the OCC condition. Thus, the CRS and the additional DMRS are simultaneously transmitted on the RE, so that a capacity of the NR PDCCH can be improved and transmission performance can be improved.

It is to be noted that determining by the terminal the position of the shifted RE by means of shifting in the frequency domain may be realized through the following manner: taking an RE corresponding to the first DMRS as an initial position, shifting in a direction of at least one of an increasing or decreasing in the frequency domain, and determining an RE not transmitting CRSs and having a smallest frequency domain spacing with the RE at the initial position as the position of the shifted RE.

The additional DMRS is different from the first DMRS. The additional DMRS may be transmitted on two REs consecutive in the time domain and occupied with transmission of the CRS, and a symbol for transmission of the additional DMRS is associated with a CRS symbol corresponding to the RE where the conflict occurs.

In some examples, the symbol of the additional DMRS received on an antenna port p, a sub-carrier k, and an OFDM symbol l satisfies conditions as follows:

a_{k,l}^{(p,μ)}=β_{DMRS}^{PDCCH}ω_{f}(k′)ωₜ(l′)r_{k,l}^{(dmrs)},k′=0,1, and l′=0,1,
where β_{DMRS}^{PDCCH} denotes a transmission power parameter for the additional DMRS, p=2000 denotes the antenna port, μ denotes sub-carrier spacing (SCS), k denotes a sub-carrier index, and l denotes an intra-slot symbol index;
in a case that the mode of OCC is the TD-OCC mode, ω_{f}(k′)=1, ωₜ(0)=−1, ωₜ(1)=1, and l′=0, 1 denotes two consecutive OFDM symbols where a CRS symbol corresponding to a same RE index corresponding to a target CRS pattern is located in a case that the TD-OCC condition is satisfied; and
in a case that the mode of OCC is the FD-OCC mode, ω_{f}(0)=−1, ω_{f}(1)=1, ωₜ(l′)=1, and k′=0, 1 denotes a RE corresponding to two consecutive CRS symbols corresponding to a same OFDM symbol index corresponding to a target CRS pattern in a case that the FD-OCC condition is satisfied.

In the example of the disclosure, orthogonally multiplexing of the RE by the additional DMRS and the CRS may be realized by using the TD-OCC mode or the FD-OCC mode. Whether the TD-OCC mode or the FD-OCC mode is selected by the terminal may be determined through signaling indication.

It can be understood that in the example of the disclosure, the target CRS pattern may be one or more CRS patterns, where different CRS patterns correspond to different CRSs. The CRS corresponding to the CRS pattern conflicts with the first DMRS on the RE.

In some examples, the target CRS pattern corresponds to a CRS pattern 1, and/or the target CRS pattern corresponds to a CRS pattern 2, where the CRS pattern 1 and the CRS pattern 2 are configured to indicate the CRSs corresponding to different CRS patterns.

In the example of the disclosure, the target CRS pattern corresponds to the CRS pattern 1. Alternatively, the target CRS pattern corresponds to the CRS pattern 2. Alternatively, the target CRS pattern corresponds to the CRS pattern 1 and the CRS pattern 2. Where the CRS pattern 1 and the CRS pattern 2 are configured to indicate the CRSs corresponding to different CRS patterns. The CRS corresponding to the CRS pattern conflicts with the first DMRS on the RE.

In some examples, the CRS is determined by the target CRS pattern, and the symbol of the additional DMRS is associated with the CRS encountering the conflict, where:
r_{k,l}^{(dmrs)}=r_{l,n}_{ₛ}^{(crs,i)}(m), where i denotes an index of the target CRS pattern, and i=1 and/or i=2; and
r_{l,n}_{ₛ}^{(crs,i)}(m) denotes a CRS symbol corresponding to a CRS pattern i, the CRS symbol is transmitted on a slot nₛ, the OFDM symbol l, and the sub-carrier k, and the sub-carrier index k corresponds to m.
   Where k=6m+ (v+v_{shift}) mod 6, m=0, 1, . . . , 2*N_{RB}^{DL}−1. Reference may be made to the description above for the meanings of v_{shift} and N_{RB}^{DL}.

In the example of the disclosure, the terminal determines the target CRS pattern according to the CRS pattern index i, so as to determine the CRS according to the target CRS pattern. In a case of determining that the index i of the target CRS pattern is n, the target CRS pattern is determined to be a CRS pattern n. For example, in a case of determining that the index i of the target CRS pattern is 1, the target CRS pattern is determined to be the CRS pattern 1. Alternatively, in a case of determining that the index i of the target CRS pattern is 2, the target CRS pattern is determined to be the CRS pattern 2. Alternatively, in a case of determining that the indexes i of the target CRS pattern are 1 and 2, the target CRS pattern is determined to be the CRS pattern 1 and the CRS pattern 2.

The index i of the target CRS pattern may be determined by the terminal in a predefined manner or through signaling indication. Different CRS pattern lists are defined, and a target CRS pattern list is associated with the target CRS pattern. For example, different CRS pattern lists, i.e. lte-CRS-PatternList1-r18 and lte-CRS-PatternList2-r18 are defined, where lte-CRS-PatternList1-r18 is associated with the target CRS pattern, and lte-CRS-PatternList2-r18 is associated with other CRS patterns.

In some examples, an indication instruction is transmitted to the terminal by the network device. The indication instruction is configured to indicate the target CRS pattern, so as to inform the terminal of simultaneously transmission of the CRS and the additional DMRS by means of the OCC on the RE configured to transmit the CRS corresponding to the target CRS pattern.

It is to be noted that the expression of corresponding processes in the DMRS transmission method performed by the terminal is consistent with the expression in the DMRS transmission method performed by the network device, and will not be repeated.

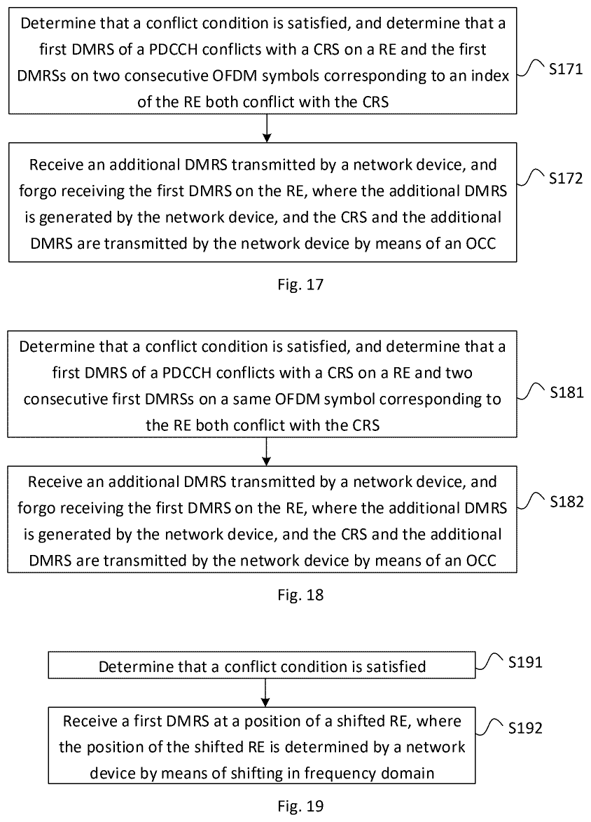

With reference to FIG. 17, FIG. 17 is a flowchart of yet another demodulation reference signal (DMRS) transmission method according to an example of the disclosure.

As shown in FIG. 17, the DMRS transmission method is performed by a terminal and may include, but is not limited to, steps S171 and S172.

Step S171 includes determining that a conflict condition is satisfied; and determining that a first DMRS of a physical downlink control channel (PDCCH) conflicts with a cell-specific reference signal (CRS) on a resource element (RE), and that the first DMRSs on two consecutive orthogonal frequency division multiplexing (OFDM) symbols corresponding to an index of the RE both conflict with the CRS.

Step S172 includes receiving an additional DMRS transmitted by a network device, and forgoing receiving the first DMRS on the RE, where the additional DMRS is generated by the network device, and the CRS and the additional DMRS are transmitted by the network device by means of an orthogonal cover code (OCC).

Reference may be made to the relevant description in the above-mentioned examples for the relevant description that the terminal determines that the conflict condition is satisfied, which will not be repeated.

Reference may be made to the relevant description in the above-mentioned examples for the relevant description that in a case that the terminal determines that the first DMRS of the PDCCH conflicts with the CRS on the RE and the first DMRSs on two consecutive OFDM symbols corresponding to the index of the RE both conflict with the CRS, the terminal receives the additional DMRS transmitted by the network device, where the additional DMRS is generated by the network device, and the CRS and the additional DMRS are transmitted by the network device by means of the OCC, which will not be repeated.

In the example of the disclosure, in a case that the terminal determines that the first DMRS of the PDCCH conflicts with the CRS on the RE and the first DMRSs on two consecutive OFDM symbols corresponding to the index of the RE both conflict with the CRS, the terminal receives the additional DMRS transmitted by the network device and forgoes receiving the first DMRS, where the additional DMRS is generated by the network device, and the CRS and the additional DMRS are transmitted by the network device by means of the OCC.

Reference may be made to the relevant description in the above-mentioned examples, and the same contents will not be repeated. The effects obtained in the example of the disclosure are identical to those obtained in the above-mentioned examples, and reference may be made to the relevant description in the above-mentioned examples for details.

With reference to FIG. 18, FIG. 18 is a flowchart of yet another demodulation reference signal (DMRS) transmission method according to an example of the disclosure.

As shown in FIG. 18, the DMRS transmission method is performed by a terminal and may include, but is not limited to, steps S181 and S182.

Step S181 includes determining that a conflict condition is satisfied; and determining that a first DMRS of a physical downlink control channel (PDCCH) conflicts with a cell-specific reference signal (CRS) on a resource element (RE), and that two consecutive first DMRSs on a same OFDM symbol corresponding to the RE both conflict with the CRS.

Step S182 includes receiving an additional DMRS transmitted by a network device, and forgoing receiving the first DMRS on the RE, where the additional DMRS is generated by the network device, and the CRS and the additional DMRS are transmitted by the network device by means of an OCC.

Reference may be made to the relevant description in the above-mentioned examples for the relevant description that the terminal determines that the conflict condition is satisfied, which will not be repeated.

Reference may be made to the relevant description in the above-mentioned examples for the relevant description that in a case that the terminal determines that the first DMRS of the PDCCH conflicts with the CRS on the RE and two consecutive first DMRSs on a same OFDM symbol corresponding to the RE both conflict with the CRS, the terminal receives the additional DMRS transmitted by the network device, where the additional DMRS is generated by the network device, and the CRS and the additional DMRS are transmitted by the network device by means of the OCC, which will not be repeated.

In the example of the disclosure, in a case that the terminal determines that the first DMRS of the PDCCH conflicts with the CRS on the RE and two consecutive first DMRSs on a same OFDM symbol corresponding to the RE both conflict with the CRS, the terminal receives the additional DMRS transmitted by the network device and forgoes receiving the first DMRS, where the additional DMRS is generated by the network device, and the CRS and the additional DMRS are transmitted by the network device by means of the OCC.

Reference may be made to the relevant description in the above-mentioned examples, and the same contents will not be repeated. The effects obtained in the example of the disclosure are identical to those obtained in the above-mentioned examples, and reference may be made to the relevant description in the above-mentioned examples for details.

With reference to FIG. 19, FIG. 19 is a flowchart of still another demodulation reference signal (DMRS) transmission method according to an example of the disclosure.

As shown in FIG. 19, the DMRS transmission method is performed by a terminal and may include, but is not limited to, steps S191 and S192.

Step S191 includes determining that a conflict condition is satisfied.

Step S192 includes receiving a first DMRS at a position of a shifted RE, where the position of the shifted RE is determined by means of shifting in the frequency domain.

Reference may be made to the relevant description in the above-mentioned examples for the relevant description that the terminal determines that the conflict condition is satisfied, which will not be repeated.

In the example of the disclosure, in a case of determining that the conflict condition is satisfied, the terminal determines the position of the shifted RE by means of shifting in the frequency domain, and receives the first DMRS at the position of the shifted RE. Thus, the terminal receives the first DMRS transmitted by the network device at the position of the shifted RE.

It is to be noted that determining by the terminal the position of the shifted RE by means of shifting in the frequency domain may be realized through the following manner: taking an RE corresponding to the first DMRS as an initial position, shifting in a direction of at least one of an increasing or decreasing in the frequency domain, and determining an RE not transmitting CRSs and having a smallest frequency domain spacing with the RE at the initial position as the position of the shifted RE.

In some examples, the conflict condition includes at least one of an orthogonal cover code of time domain (TD-OCC) condition or an orthogonal cover code of frequency domain (FD-OCC) condition.

In some examples, the TD-OCC condition is as follows: a first DMRS of a PDCCH conflicts with the CRS on the RE, and the first DMRSs on two consecutive OFDM symbols corresponding to an index of the RE both conflict with the CRS.

In some examples, the FD-OCC condition is as follows: a first DMRS of a PDCCH conflicts with the CRS on the RE, and two consecutive first DMRSs on a same OFDM symbol corresponding to the RE both conflict with the CRS.

In the example of the disclosure, in a case of determining that the conflict condition is satisfied, the terminal determines the position of the shifted RE by means of shifting in the frequency domain, and receives the first DMRS at the position of the shifted RE.

It is to be noted that determining by the terminal the position of the shifted RE by means of shifting in the frequency domain may be realized through the following manner: taking an RE corresponding to the first DMRS as an initial position, shifting in a direction of at least one of an increasing or decreasing in the frequency domain, and determining an RE not transmitting CRSs and having a smallest frequency domain spacing with the RE at the initial position as the position of the shifted RE.

Reference may be made to the relevant description in the above-mentioned examples, and the same contents will not be repeated. The effects obtained in the example of the disclosure are identical to those obtained in the above-mentioned examples, and reference may be made to the relevant description in the above-mentioned examples for details.

In the above-mentioned examples of the disclosure, the DMRS transmission methods according to the examples of the disclosure are described from the perspectives of the network device and the terminal separately. In order to implement each function in the DMRS transmission methods according to the examples of the disclosure, the network device and the terminal may each include a hardware structure and a software module, and implement the function in a form of the hardware structure, the software module, or the hardware structure plus the software module. One of the functions may be executed in a form of the hardware structure, the software module, or the hardware structure plus the software module.

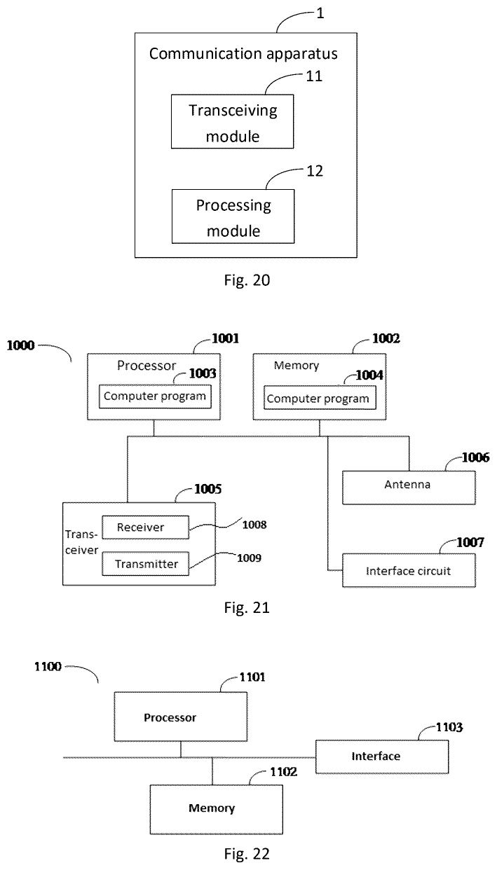

With reference to FIG. 20, FIG. 20 is a schematic structural diagram of a communication apparatus 1 according to an example of the disclosure. The communication apparatus 1 shown in FIG. 20 may include a transceiving module 11 and a processing module 12. The transceiving module 11 may include at least one of a transmission module or a reception module, where the transmission module is configured to implement a function of transmission, the reception module is configured to implement a function of reception, and the transceiving module 11 may implement at least one of the function of transmission or the function of reception.

The communication apparatus 1 may be a network device, an apparatus in the network device, or an apparatus that may be used in conjunction with the network device. Alternatively, the communication apparatus 1 may be a terminal, an apparatus in the terminal, or an apparatus that may be used in conjunction with the terminal.

A case where the communication apparatus 1 is the network device will be described below.

In an embodiment, the processing module 12 is configured to determine that a conflict condition is satisfied.

The processing module 12 is further configured to generate an additional DMRS.

The transceiving module 11 is configured to transmit a cell-specific reference signal (CRS) and the additional DMRS by means of an orthogonal cover code (OCC).

In some examples, the conflict condition includes at least one of an orthogonal cover code of time domain (TD-OCC) condition or an orthogonal cover code of frequency domain (FD-OCC) condition.

In some examples, the TD-OCC condition is as follows: a first DMRS of a physical downlink control channel (PDCCH) conflicts with the CRS on a resource element (RE), and first DMRSs on two consecutive orthogonal frequency division multiplexing (OFDM) symbols corresponding to an index of the RE both conflict with the CRS.

In some examples, the FD-OCC condition is as follows: a first DMRS of a PDCCH conflicts with the CRS on a RE, and two consecutive first DMRSs on a same OFDM symbol corresponding to the RE both conflict with the CRS.

In some examples, the transceiving module 11 is further configured to forgo transmitting the first DMRS.

In some examples, a mode of the OCC includes at least one of a TD-OCC mode or a FD-OCC mode.

In some examples, a symbol of the additional DMRS transmitted on an antenna port p, a sub-carrier k, and an OFDM symbol l satisfies conditions as follows:

a_{k,l}^{(p,μ)}=β_{DMRS}^{PDCCH}ω_{f}(k′)ωₜ(l′)r_{k,l}^{(dmrs)},k′=0,1, and l′=0,1,
where β_{DMRS}^{PDCCH} denotes a transmission power parameter for the additional DMRS, p=2000 denotes the antenna port, μ denotes sub-carrier spacing (SCS), k denotes a sub-carrier index, and l denotes an intra-slot symbol index;
in a case that the mode of OCC is the TD-OCC mode, ω_{f}(k′)=1, ωₜ(0)=−1, ωₜ(1)=1, and l′=0, 1 denotes two consecutive OFDM symbols where a CRS symbol corresponding to a same RE index corresponding to a target CRS pattern is located in a case that the TD-OCC condition is satisfied; and
in a case that the mode of OCC is the FD-OCC mode, ω_{f}(0)=−1, ω_{f}(1)=1, ωₜ(l′)=1, and k′=0, 1 denotes a RE index corresponding to two consecutive CRS symbols corresponding to a same OFDM symbol index corresponding to a target CRS pattern in a case that the FD-OCC condition is satisfied.

In some examples, the target CRS pattern corresponds to a CRS pattern 1, and/or
the target CRS pattern corresponds to a CRS pattern 2,
where the CRS pattern 1 and the CRS pattern 2 are configured to indicate CRSs corresponding to different CRS patterns.

In some examples, the CRS is determined by the target CRS pattern,
where r_{k,l}^{(dmrs)}=r_{l,n}_{ₛ}^{(crs,i)}(m), where i denotes an index of the target CRS pattern, and i=1 and/or i=2; and
r_{l,n}_{ₛ}^{(crs,i)}(m) denotes a CRS symbol corresponding to a CRS pattern i, the CRS symbol is transmitted on a slot nₛ, the OFDM symbol l, and the sub-carrier k, and the sub-carrier index k corresponds to m.

In some examples, the first DMRS and the additional DMRS of the PDCCH belong to a NR system, and the CRS belongs to an LTE system.

In another embodiment, the processing module 12 is configured to determine that a conflict condition is satisfied.

The processing module 12 is further configured to determine a position of a shifted RE by means of shifting in the frequency domain.

The transceiving module 11 is configured to transmit a first DMRS at the position of the shifted RE.

In some examples, the conflict condition includes at least one of an orthogonal cover code of time domain (TD-OCC) condition or an orthogonal cover code of frequency domain (FD-OCC) condition.

In some examples, the TD-OCC condition is as follows: a first DMRS of a PDCCH conflicts with the CRS on a RE, and first DMRSs on two consecutive OFDM symbols corresponding to an index of the RE both conflict with the CRS.

In some examples, the FD-OCC condition is as follows: a first DMRS of a PDCCH conflicts with the CRS on a RE, and two consecutive first DMRSs on a same OFDM symbol corresponding to the RE both conflict with the CRS.

In some examples, the first DMRS of the PDCCH belongs to a NR system, and the CRS belongs to an LTE system.

A case where the communication apparatus 1 is the terminal will be described below.

In an embodiment, the processing module 12 is configured to determine that a conflict condition is satisfied.

The transceiving module 11 is configured to receive an additional DMRS transmitted by a network device, where the additional DMRS is generated by the network device, and a CRS and the additional DMRS are transmitted by the network device by means of an OCC.

In some examples, the conflict condition includes at least one of an orthogonal cover code of time domain (TD-OCC) condition or an orthogonal cover code of frequency domain (FD-OCC) condition.

In some examples, the TD-OCC condition is as follows: a first DMRS of a PDCCH conflicts with the CRS on a RE, and first DMRSs on two consecutive OFDM symbols corresponding to an index of the RE both conflict with the CRS.

In some examples, the FD-OCC condition is as follows: a first DMRS of a PDCCH conflicts with the CRS on a RE, and two consecutive first DMRSs on a same OFDM symbol corresponding to the RE both conflict with the CRS.

In some examples, the transceiving module 11 is further configured to forgo receiving the first DMRS on the RE.

In some examples, a mode of the OCC includes at least one of a TD-OCC mode or a FD-OCC mode.

In some examples, a symbol of the additional DMRS received on an antenna port p, a sub-carrier k, and an OFDM symbol l satisfies conditions as follows:

a_{k,l}^{(p,μ)}=β_{DMRS}^{PDCCH}ω_{f}(k′)ωₜ(l′)r_{k,l}^{(dmrs)},k′=0,1, and l′=0,1,
where β_{DMRS}^{PDCCH} denotes a transmission power parameter for the additional DMRS, p=2000 denotes the antenna port, μ denotes sub-carrier spacing (SCS), k denotes a sub-carrier index, and l denotes an intra-slot symbol index;
in a case that the mode of OCC is the TD-OCC mode, ω_{f}(k′)=1, ωₜ(0)=−1, ωₜ(1)=1, and l′=0, 1 denotes two consecutive OFDM symbols where a CRS symbol corresponding to a same RE index corresponding to a target CRS pattern is located in a case that the TD-OCC condition is satisfied; and
in a case that the mode of OCC is the FD-OCC mode, ω_{f}(0)=−1, ω_{f}(1)=1, ωₜ(l′)=1, and k′=0, 1 denotes a RE index corresponding to two consecutive CRS symbols corresponding to a same OFDM symbol index corresponding to a target CRS pattern in a case that the FD-OCC condition is satisfied.

In some examples, the target CRS pattern corresponds to a CRS pattern 1, and/or
the target CRS pattern corresponds to a CRS pattern 2,
where the CRS pattern 1 and the CRS pattern 2 are configured to indicate CRSs corresponding to different CRS patterns.

In some examples, the CRS is determined by the target CRS pattern,
where r_{k,l}^{(dmrs)}=r_{l,n}_{ₛ}^{(crs,i)}(m), where i denotes an index of the target CRS pattern, and i=1 and/or i=2; and
r_{l,n}_{ₛ}^{(crs,i)}(m) denotes a CRS symbol corresponding to a CRS pattern i, the CRS symbol is transmitted on a slot nₛ, the OFDM symbol l, and the sub-carrier k, and the sub-carrier index k corresponds to m.

In some examples, the first DMRS and the additional DMRS of the PDCCH belong to a NR system, and the CRS belongs to an LTE system.

In another embodiment, the processing module 12 is configured to determine that a conflict condition is not satisfied.

The transceiving module 11 is configured to receive a first DMRS at a position of a shifted RE, where the position of the shifted RE is determined by means of shifting in the frequency domain.

In some examples, the conflict condition includes at least one of an orthogonal cover code of time domain (TD-OCC) condition or an orthogonal cover code of frequency domain (FD-OCC) condition.

In some examples, the TD-OCC condition is as follows: a first DMRS of a PDCCH conflicts with a CRS on a RE, and first DMRSs on two consecutive OFDM symbols corresponding to an index of the RE both conflict with the CRS.

In some examples, the FD-OCC condition is as follows: a first DMRS of a PDCCH conflicts with a CRS on a RE, and two consecutive first DMRSs on a same OFDM symbol corresponding to the RE both conflict with the CRS.

In some examples, the first DMRS of the PDCCH belongs to a NR system, and the CRS belongs to an LTE system.

A way of each module of the communication apparatus 1 to execute the operation has been described in detail in the example relating to the DMRS transmission method, and will not be described in detail.

The communication apparatus 1 according to the examples of the disclosure obtains the same or similar beneficial effects as the DMRS transmission methods according to the examples of the disclosure, which will not be repeated.

With reference to FIG. 21, FIG. 21 is a schematic structural diagram of another communication apparatus 1000 according to an example of the disclosure. The communication apparatus 1000 may be a network device; a terminal; a chip, a chip system, a processor, etc. that supports the network device in implementing the DMRS transmission method; and a chip, a chip system, a processor, etc. that supports the terminal in implementing the DMRS transmission method. The communication apparatus 1000 may be configured to implement the method described in the method example, and reference may be made to the description in the method example for details.

The communication apparatus 1000 may include one or more processors 1001. The processor 1001 may be a general-purpose processor, or a special-purpose processor, etc. For example, the processor 1001 may be a baseband processor or a central processing unit. The baseband processor may be configured to process communication protocols and communication data. The central processing unit may be configured to control the communication apparatus (such as a base station, baseband chip, a terminal, a terminal chip, a DU, and a CU), execute a computer program 1003, and process data of the computer program 1003.

The communication apparatus 1000 may further include one or more memories 1002, where the memory 1002 stores a computer program 1004, the memory 1002 causes the communication apparatus 1000 to execute the method described in the method example by executing the computer program 1004. The memory 1002 may also store data. The communication apparatus 1000 and the memory 1002 may be arranged separately or integrated together.

The communication apparatus 1000 may further include a transceiver 1005 and an antenna 1006. The transceiver 1005 may be referred to as a transceiving unit, a transceiving machine, or a transceiving circuit, etc., and is configured to implement a function of transceiving. The transceiver 1005 may include a receiver1008 and a transmitter 1009, where the receiver 1008 may be referred to as a reception machine, or a reception circuit, etc., and is configured to implement a function of reception; and the transmitter 1009 may be referred to as a transmission machine, or a transmission circuit, etc., and is configured to implement a function of transmission.

The communication apparatus 1000 may further include one or more interface circuits 1007. The interface circuit 1007 is configured to receive a code instruction, and transmit the code instruction to the processor 1001. The processor 1001 causes the communication apparatus 1000 to execute the method described in the method example by running the code instruction.

In a case that the communication apparatus 1000 is a network device: the processor 1001 is configured to execute steps S61 and S62 in FIG. 6, steps S131 and S132 in FIG. 13, steps S141 and S142 in FIG. 14, and steps S151 and S152 in FIG. 15; and the transceiver 1005 is configured to execute step S63 in FIG. 6, step S133 in FIG. 13, step S143 in FIG. 14, and step S153 in FIG. 15.

In a case that the communication apparatus 1000 is a terminal: the processor 1001 is configured to execute step S161 in FIG. 16, step S171 in FIG. 17, step S181 in FIG. 18, and step S191 in FIG. 19; and the transceiver 1005 is configured to execute step S162 in FIG. 16, step S172 in FIG. 17, step S182 in FIG. 18, and step S192 in FIG. 19.

In an embodiment, the processor 1001 may include a transceiver (not shown) configured to implement functions of reception and transmission. For example, the transceiver may be a transceiving circuit, an interface, or an interface circuit. The transceiving circuit, interface, or interface circuit configured to implement the functions of reception and transmission may be separated or integrated together. The transceiving circuit, interface, or interface circuit may be configured to read and write codes/data. Alternatively, the transceiving circuit, interface, or interface circuit may be configured to transmit or transfer a signal.

In an embodiment, the processor 1001 may store a computer program 1003, where when running on the processor 1001, the computer program 1003 may cause the communication apparatus 1000 to execute the method described in the method example. The computer program 1003 may be firmed in the processor 1001. In this case, the processor 1001 may be implemented by hardware.

In an embodiment, the communication apparatus 1000 may include a circuit (not shown), where the circuit may implement the function of transmission, reception, or communication in the method example. The processor 1001 and the transceiver 1005 described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor 1001 and the transceiver 1005 may also be fabricated through various IC process technologies, such as a complementary metal oxide semiconductor (CMOS), an nmetal-oxide-semiconductor (NMOS), a positive channel metal oxide semiconductor (PMOS), a bipolar junction transistor (BJT), a bipolar CMOS (BICMOS), silicon germanium (SiGe), and gallium arsenide (GaAs).

The communication apparatus 1000 described in the above-mentioned examples may be a terminal, but the scope of the communication apparatus 1000 described in the disclosure is not limited to this. The structure of the communication apparatus 1000 may not be limited by FIG. 21. The communication apparatus 1000 may be a stand-alone device or a part of a large device. For example, the communication apparatus 1000 may be:
(1) an independent integrated circuit (IC), a chip, a chip system, or a chip sub system;
(2) a set having one or more ICs, which may include a storage component configured to store data and computer programs;
(3) an ASIC, such as a modem;
(4) a module, which may be embedded in other devices;
(5) a receiver, a terminal, a smart terminal, a cellular phone, a wireless device, a handset, a mobile unit, a vehicle-mounted device, a network device, a cloud device, an artificial intelligence device, etc.; and
(6) other apparatus, etc.

Reference may be made to FIG. 22 that is a structural diagram of a chip according to an example of the disclosure for the case where the communication apparatus 1000 may be the chip or the chip system.

The chip 1100 includes a processor 1101 and an interface 1103. One or more processors 1101 may be provided, and a plurality of interfaces 1103 may be provided.

In a case that the chip 1100 is configured to implement the functions of the terminal in the example of the disclosure:
the interface 1103 is configured to receive a code instruction, and transmit the code instruction to the processor 1101; and
the processor 1101 is configured to execute the demodulation reference signal (DMRS) transmission method in some above-mentioned examples by running the code instruction.

In a case that the chip 1100 is configured to implement the functions of the network device in the example of the disclosure:
the interface 1103 is configured to receive a code instruction, and transmit the code instruction to the processor 1101; and
the processor 1101 is configured to execute the demodulation reference signal (DMRS) transmission method in some above-mentioned examples by running the code instruction.

In an example, the chip 1100 further includes a memory 1102, where the memory 1102 is configured to store necessary computer programs and data.

Those skilled in the art can also appreciate that various illustrative logical blocks and steps in the examples of the disclosure can be implemented through electronic hardware, computer software, or combinations of both. Whether such functions are implemented through the hardware or the software depends on the application and overall system design requirements. Those skilled in the art can use the functions implemented through various methods for each application, but such an implementation should not be interpreted as exceeding the scope of protection of the examples of the disclosure.

A communication system (not shown) is further provided in the examples of the disclosure. The communication system includes the communication apparatus serving as the terminal and the communication apparatus serving as the network device in the example in FIG. 20. Alternatively, the communication system may include the communication apparatus serving as the terminal and the communication apparatus serving as the network device in the example in FIG. 21.

The disclosure further provides a non-transitory computer-readable storage medium. The non-transitory computer-readable storage medium stores an instruction, where when executed by a computer, the instruction implements the functions in any method example described.

The disclosure further provides a computer program product. When executed by a computer, the computer program product implements the functions in any method example described.

In the above-mentioned examples, some or all of the functions may be implemented through software, hardware, firmware, or any combinations thereof. When implemented through the software, some or all of the functions may be implemented in a form of the computer program product. The computer program product includes one or more computer programs. When loaded and executed on the computer, some or all of the computer programs generate the flows or functions according to the example of the disclosure. The computer can be a general-purpose computer, a special-purpose computer, a computer network, or another programmable apparatus. The computer program can be stored in a non-transitory computer-readable storage medium, or transmitted from one non-transitory computer-readable storage medium to another non-transitory computer-readable storage medium, for example, from one website, computer, server, or data center to another website, computer, server, or data center through a wired means (for example, a coaxial cable, an optical fiber, and a digital subscribe line (DSL)), or a wireless means (for example, infrared, radio waves, and microwaves). The non-transitory computer-readable storage medium can be any available medium that a computer can access, or an integrated server, data center, etc. encompassing one or more available media. The available medium can be a magnetic medium (for example, a floppy disk, a hard disk, or a tape), an optical medium (for example, a digital video disk (DVD)), a semiconductor medium (for example, a solid state disk (SSD)), etc.

The demodulation reference signal (DMRS) transmission method and apparatus are provided in examples of the disclosure. A new radio-physical downlink control channel (NR PDCCH) and a long term evolution-cell-specific reference signal (LTE CRS) are simultaneously transmitted by means of orthogonal cover code (OCC), and an additional demodulation reference signal (DMRS) is transmitted on a resource occupied with transmission of the CRS. Accordingly, a capacity of the NR PDCCH can be improved and transmission performance can be improved.

Those of ordinary skill in the art can understand that various numerical numbers such as first and second involved in the disclosure are for convenience of description, instead of limiting the scope of the examples of the disclosure, and also does not indicate a successive sequence.

Words “at least one of” in the disclosure can also be described as one or more, and words “a plurality of” can indicate two, three, four, or more, which is not limited in the disclosure. In the examples of the disclosure, technical features in a kind of technical features are distinguished by “first”, “second”, “third”, “A”, “B”, “C”, and “D”, and there is no successive sequence or magnitude sequence among the technical features described by “first”, “second”, “third”, “A”, “B”, “C”, and “D”.

Correspondence relations shown in each table of the disclosure can be configured or pre-defined. Values of information in each table are illustrative, and can be configured as other values, which is not limited in the disclosure. When a correspondence relation between the information and each parameter is configured, it is not necessarily required to configure all the correspondence relations indicated in each table. For example, in the table of the disclosure, the corresponding relations shown in some rows may not be configured. For another example, appropriate deformation and adjustment, such as splitting and merging, can be made based on the above-mentioned table. The name of the parameter shown in the title of each table can also employ other names that are understandable by the communication apparatus, and the value or expression mode of the parameter can also employ other values or expression modes that are understandable by the communication apparatus. When implemented, each table can also employ other data structures, such as an array, a queue, a container, a stack, a linear table, a pointer, a linked list, a tree, a graph, a structural body, a class, a heap, and a hash table.

Wording “pre-defining” in the disclosure can be interpreted as defining, pre-defining, storing, pre-storing, pre-negotiating, pre-configuring, firming, or pre-firing.

Those of ordinary skill in the art can appreciate that the units and algorithm steps of all instances described in combination with the examples disclosed can be implemented through electronic hardware, or combinations of computer software and electronic hardware. Whether these functions are performed through hardware or software depends on the application of the technical solution and design constraint conditions. Those skilled in the art can implement the functions described through different methods for each application, but such an implementation should not be deemed as exceeding the scope of the disclosure.

Those skilled in the art can clearly understand that for convenience and brevity of description, reference can be made to the corresponding processes in the method example for operating processes of the above-mentioned system, apparatus, and unit, which will not be repeated.

What are described are the embodiments of the disclosure, but the scope of protection of the disclosure is not limited to this. Changes or substitutions that can be readily conceived by those skilled in the art within the technical scope disclosed by the disclosure should fall within the scope of protection of the disclosure. Thus, the scope of protection of the disclosure is to be defined by the scope of protection of the claims.

1. A demodulation reference signal (DMRS) transmission method, performed by a network device, comprising:
determining that a conflict condition is satisfied;
generating an additional DMRS; and
transmitting a cell-specific reference signal (CRS) and the additional DMRS by means of an orthogonal cover code (OCC).

2. The method according to claim 1, wherein the conflict condition comprises at least one of an orthogonal cover code of time domain (TD-OCC) condition or an orthogonal cover code of frequency domain (FD-OCC) condition.

3. The method according to claim 2, wherein the TD-OCC condition is as follows:
a first DMRS of a physical downlink control channel (PDCCH) conflicts with the CRS on a resource element (RE), and the first DMRSs on two consecutive orthogonal frequency division multiplexing (OFDM) symbols corresponding to an index of the RE both conflict with the CRS;
or
wherein the FD-OCC condition is as follows:
a first DMRS of a physical downlink control channel (PDCCH) conflicts with the CRS on a resource element (RE), and two consecutive first DMRSs on a same orthogonal frequency division multiplexing (OFDM) symbol corresponding to the RE both conflict with the CRS.

4. (canceled)

5. The method according to claim 3, further comprising:
forgoing transmitting the first DMRS on the RE.

6. The method according to claim 1, wherein a mode of the OCC comprises at least one of an orthogonal cover code of time domain (TD-OCC) mode or an orthogonal cover code of frequency domain (FD-OCC) mode.

7. The method according to claim 6, wherein a symbol of the additional DMRS transmitted on an antenna port p, a sub-carrier k, and an OFDM symbol l satisfies conditions as follows:
a_{k,l}^{(p,μ)}=β_{DMRS}^{PDCCH}ω_{f}(k′)ωₜ(l′)r_{k,l}^{(dmrs)},k′=0,1, and l′=0,1,
wherein β_{DMRS}^{PDCCH} denotes a transmission power parameter for the additional DMRS, p=2000 denotes the antenna port, μ denotes sub-carrier spacing (SCS), k denotes a sub-carrier index, and l denotes an intra-slot symbol index;
in a case that the mode of the OCC is the TD-OCC mode, ω_{f}(k′)=1, ωₜ(0)=−1, ωₜ(1)=1, and l′=0, 1 denotes two consecutive OFDM symbols where a CRS symbol corresponding to a same RE index corresponding to a target CRS pattern is located in a case that the TD-OCC condition is satisfied; and
in a case that the mode of the OCC is the FD-OCC mode, ω_{f}(0)=−1, ω_{f}(1)=1, ωₜ(l′)=1, and k′=0, 1 denotes a RE corresponding to two consecutive CRS symbols corresponding to a same OFDM symbol index corresponding to a target CRS pattern in a case that the FD-OCC condition is satisfied.

8. The method according to claim 7, wherein
the target CRS pattern corresponds to a CRS pattern 1, and/or
the target CRS pattern corresponds to a CRS pattern 2,
wherein the CRS pattern 1 and the CRS pattern 2 are configured to indicate CRSs corresponding to different CRS patterns;
wherein the CRS is determined by the target CRS pattern;
wherein r_{k,l}^{(dmrs)}=r_{l,n}_{ₛ}^{(crs,i)}(m), wherein i denotes an index of the target CRS pattern, and i=1 or i=2;
r_{l,n}_{ₛ}^{(crs,i)}(m) denotes a CRS symbol corresponding to a CRS pattern i, the CRS symbol is transmitted on a slot nₛ, the OFDM symbol l, and the sub-carrier k, and the sub-carrier index k corresponds to m.

9-17. (canceled)

18. A demodulation reference signal (DMRS) transmission method, performed by a terminal, comprising:
determining that a conflict condition is satisfied;
receiving an additional DMRS transmitted by a network device, wherein the additional DMRS is generated by the network device, and a cell-specific reference signal (CRS) and the additional DMRS are transmitted by the network device by means of an orthogonal cover code (OCC).

19. The method according to claim 18, wherein the conflict condition comprises at least one of an orthogonal cover code of time domain (TD-OCC) condition or an orthogonal cover code of frequency domain (FD-OCC) condition.

20. The method according to claim 19, wherein the TD-OCC condition is as follows:
a first DMRS of a physical downlink control channel (PDCCH) conflicts with the CRS on a resource element (RE), and the first DMRSs on two consecutive orthogonal frequency division multiplexing (OFDM) symbols corresponding to an index of the RE both conflict with the CRS;
or
wherein the FD-OCC condition is as follows:
a first DMRS of a physical downlink control channel (PDCCH) conflicts with the CRS on a resource element (RE), and two consecutive first DMRSs on a same orthogonal frequency division multiplexing (OFDM) symbol corresponding to the RE both conflict with the CRS.

21. (canceled)

22. The method according to claim 20, further comprising:
forgoing receiving the first DMRS on the RE.

23. The method according to claim 18, wherein a mode of the OCC comprises at least one of an orthogonal cover code of time domain (TD-OCC) mode or an orthogonal cover code of frequency domain (FD-OCC) mode.

24. The method according to claim 23, wherein a symbol of the additional DMRS received on an antenna port p, a sub-carrier k, and an OFDM symbol l satisfies conditions as follows:
a_{k,l}^{(p,μ)}=β_{DMRS}^{PDCCH}ω_{f}(k′)ωₜ(l′)r_{k,l}^{(dmrs)},k′=0,1, and l′=0,1,
wherein β_{DMRS}^{PDCCH} denotes a transmission power parameter for the additional DMRS, p=2000 denotes the antenna port, μ denotes sub-carrier spacing (SCS), k denotes a sub-carrier index, and l denotes an intra-slot symbol index;
in a case that the mode of the OCC is the TD-OCC mode, ω_{f}(k′)=1, ωₜ(0)=−1, ωₜ(1)=1, and l′=0, 1 denotes two consecutive OFDM symbols where a CRS symbol corresponding to a same RE index corresponding to a target CRS pattern is located in a case that the TD-OCC condition is satisfied; and
in a case that the mode of the OCC is the FD-OCC mode, ω_{f}(0)=−1, ω_{f}(1)=1, ωₜ(l′)=1, and k′=0, 1 denotes a RE corresponding to two consecutive CRS symbols corresponding to a same OFDM symbol index corresponding to a target CRS pattern in a case that the FD-OCC condition is satisfied.

25. The method according to claim 24, wherein
the target CRS pattern corresponds to a CRS pattern 1, and/or
the target CRS pattern corresponds to a CRS pattern 2,
wherein the CRS pattern 1 and the CRS pattern 2 are configured to indicate CRSs corresponding to different CRS patterns-;
wherein the CRS is determined by the target CRS pattern;
wherein r_{k,l}^{(dmrs)}=r_{l,n}_{ₛ}^{(crs,i)}(m), where i denotes an index of the target CRS pattern, and i=1 or i=2; and
r_{l,n}_{ₛ}^{(crs,i)}(m) denotes a CRS symbol corresponding to a CRS pattern i, the CRS symbol is transmitted on a slot nₛ, the OFDM symbol l, and the sub-carrier k, and the sub-carrier index k corresponds to m.

26-27. (canceled)

28. A demodulation reference signal (DMRS) transmission method, performed by a terminal, comprising:
determining that a conflict condition is not satisfied; and
receiving a first DMRS at a position of a shifted resource element (RE), wherein the position of the shifted RE is determined by means of shifting in frequency domain.

29. The method according to claim 28, wherein the conflict condition comprises at least one of an orthogonal cover code of time domain (TD-OCC) condition or an orthogonal cover code of frequency domain (FD-OCC) condition;
wherein the TD-OCC condition is as follows: a first DMRS of a physical downlink control channel (PDCCH) conflicts with a cell-specific reference signal (CRS) on a RE, and the first DMRSs on two consecutive orthogonal frequency division multiplexing (OFDM) symbols corresponding to an index of the RE both conflict with the CRS; or
wherein the FD-OCC condition is as follows: a first DMRS of a physical downlink control channel (PDCCH) conflicts with a cell-specific reference signal (CRS) on a RE, and two consecutive first DMRSs on a same orthogonal frequency division multiplexing (OFDM) symbol corresponding to the RE both conflict with the CRS.

30-38. (canceled)

39. A communication apparatus, comprising a processor and a memory, wherein the memory stores a computer program; and the processor causes the communication apparatus to execute the method according to claim 1 by executing the computer program stored in the memory.

40. (canceled)

41. A non-transitory computer-readable storage medium, configured to store an instruction, wherein the instruction, when being executed, causes the method according to claim 1 to be implemented.

42. A communication apparatus, comprising a processor and a memory, wherein the memory stores a computer program; and the processor causes the communication apparatus to execute the method according to claim 18 by executing the computer program stored in the memory.

43. A communication apparatus, comprising a processor and a memory, wherein the memory stores a computer program; and the processor causes the communication apparatus to execute the method according to claim 28 by executing the computer program stored in the memory.
